(19) United States
(12) Patent Application Publication
(10) Pub. No.: US 2017/0135115 A1
(43) Pub. Date: May 11, 2017

(54) METHOD AND APPARATUS FOR TRANSMITTING AND RECEIVING DATA FOR MOBILE TERMINAL IN WIRELESS COMMUNICATION SYSTEM

(71) Applicant: LG ELECTRONICS INC., Seoul (KR)

(72) Inventors: Heejeong CHO, Seoul (KR); Genebeck HAHN, Seoul (KR); Eunjong LEE, Seoul (KR); Ilmu BYUN, Seoul (KR)

(73) Assignee: LG ELECTRONICS INC., Seoul (KR)

(21) Appl. No.: 14/937,458

(22) Filed: Nov. 10, 2015

(51) Int. Cl. H04W 72/08; H04W 74/08

(52) U.S. Cl. CPC H04W 72/085; H04W 74/08

(57) ABSTRACT

This document discloses a method and an apparatus for transmitting and receiving data in a wireless communication system supporting a specific service. A mobile terminal according to the present invention transmits a preamble and data for the specific service to a base station; and receives feedback information carrying a reception result of the preamble and the data from the base station. Based on the feedback information, the mobile terminal may not re-transmit the preamble and the data to the base station or re-transmit at least one of the preamble or the data to the base station, wherein the preamble and the data are transmitted through a first contention based channel, the first contention based channel is not a dedicated channel for a specific UE.

### BACKGROUND OF THE INVENTION

Field of the Invention

The present invention is related to a method for transmitting and receiving data for a mobile terminal in a wireless communication system; and more specifically, a method for transmitting and receiving data for a mobile terminal to provide specific services not only in a connected state but also in an idle state and an apparatus supporting the method.

Discussion of the Related Art

Mobile communication systems have emerged to provide a voice service while guaranteeing mobility of a user. The mobile communication system of today has been expanded to support data services in addition to the voice service. Due to the explosive increase of today's traffic, resources are running short; more and more users are demanding higher speed services; and a more advanced mobile communication system is required accordingly.

Key requirements for a next-generation mobile communication system include accommodation of explosive data traffic, significant increase of transmission rate per user, accommodation of a significantly increased number of connected devices, very low end-to-end latency, and high energy efficiency. In order to meet the requirements, various technologies such as dual connectivity, massive Multiple Input Multiple Output (MIMO), in-band full duplex, Non-Orthogonal Multiple Access (NOMA), super wideband, and device networking are being studied.

### SUMMARY OF THE INVENTION

The present invention provides a method for a mobile terminal in a wireless communication system to transmit and receive data without using resources allocated by a base station.

Also, the present invention provides a method for a mobile terminal in an idle state as well as in a connected state in a wireless communication system to transmit or re-transmit data for providing a specific service without using resources allocated by a base station.

Also, the present invention provides a method for a mobile terminal in an idle state as well as in a connected state in a wireless communication system to transmit or re-transmit data for providing a specific service by using resources not limited to a specific terminal.

Technical objects of the present invention are not limited to those objects described above; other technical objects not mentioned above can be clearly understood from what are described below by those skilled in the art to which the present invention belongs.

To solve the technical problems above, the present invention provides a method and an apparatus for transmitting and receiving data in a wireless communication system.

More specifically, a method for transmitting and receiving data according to one embodiment of the present invention comprises transmitting a preamble and data for a specific service to an eNB; receiving feedback information carrying a reception result of the preamble and the data from the eNB; and re-transmitting at least one of the data or the preamble, if the feedback information indicates failure of reception of at least one of the data or the preamble, wherein the preamble and the data are transmitted through a first contention based channel, the first contention based channel is not a dedicated channel for a specific UE.

The present invention further comprises receiving a response message in response to the data from the eNB, if the feedback information indicates reception of the preamble and the data.

The response message according to the present invention is masked as a UE identifier or a channel identifier representing the contention based channel.

The re-transmitting step according to the present invention further comprises receiving resources allocated for re-transmission of the data from the eNB, if the feedback information indicates reception of the preamble only; and re-transmitting the data through the allocated resources.

The preamble and the data are retransmitted to the eNB through the first contention based channel, if the feedback information indicates reception of the preamble only.

The preamble and the data are retransmitted to the eNB through a second contention based channel, if the feedback information indicates reception of the preamble only, and the second contention based channel is different from the first contention based channel.

The preamble and the data are retransmitted to the eNB through the first contention based channel, if the feedback information indicates failure of reception of the preamble and the dat.

The preamble and the data are retransmitted to the eNB through the second contention based channel, if the feedback information indicates failure of reception of the preamble and the data.

The feedback information according to the present invention is transmitted through a specific channel corresponding to the contention based channel.

A UE according to the present invention comprises a communication unit transmitting and receiving a radio signal to and from an external entity; and a processor functionally linked to the communication unit, wherein the processor is configured to transmit a preamble and data for a specific service to an eNB; to receive feedback information carrying a reception result of the preamble and the data from the eNB; and to re-transmit at least one of the data or the preamble, if the feedback information indicates failure of reception of at least one of the data or the preamble, wherein the preamble and the data are transmitted through a first contention based channel, the first contention based channel is not a dedicated channel for a specific UE.

If the feedback information indicates receiving the preamble and the data, the processor is configured to receive a response message in response to the data from the eNB.

The response message is masked with a UE identifier or a channel identifier representing the contention based channel.

If the feedback information indicates reception of the preamble only, the processor is configured to receive resources allocated for re-transmission of the data from the eNB and to re-transmit the data through the allocated resources.

The preamble and the data are retransmitted to the eNB through the first contention based channel, if the feedback information indicates reception of the preamble only.

The preamble and the data are retransmitted to the eNB through a second contention based channel, if the feedback information indicates reception of the preamble only, and the second contention based channel is different from the first contention based channel.

The preamble and the data are retransmitted to the eNB through the first contention based channel, if the feedback information indicates failure of reception of the preamble and the data.

The preamble and the data are retransmitted to the eNB through the second contention based channel, if the feedback information indicates failure of reception of the preamble and the data.

The feedback information is transmitted through a specific channel corresponding to the contention based channel.

A mobile terminal according to the present invention can transmit data for providing a specific service to a base station.

A mobile terminal according to the present invention can transmit or re-transmit data for providing a specific service to a base station without using resources allocated by the base station.

According to the present invention, a mobile terminal in an idle state as well as in a connected state can transmit or re-transmit data for providing a specific service to a base station without using resources allocated by the base station.

According to the present invention, a mobile terminal in an idle state as well as in a connected state can transmit or re-transmit data for providing a specific service to a base station through resources not limited to a specific terminal.

According to the present invention, a mobile terminal in an idle state as well as in a connected state can transmit data for providing a specific service to a base station through resources allocated by the base station or through resources not limited to a specific terminal, thereby improving efficiency of utilizing radio resources.

The advantageous effects that can be obtained from the present invention are not limited to those described above, and other effects not mentioned above can be understood clearly from the following descriptions by those skilled in the art to which the present invention belongs.

### BRIEF DESCRIPTION OF THE DRAWINGS

FIG. 1 is a view illustrating an Evolved Packet System which is associated with the Long Term Evolution (LTE) system to which the present invention can be applied.

FIG. 2 illustrates a wireless communication system to which the present invention is @.

FIG. 3 illustrates a functional split of an E-UTRAN and an EPC to which the present invention can be applied.

FIG. 4 (a) is a diagram illustrating a radio protocol architecture for a user plane. FIG. 4 (b) is a diagram illustrating a radio protocol architecture for a control plane.

FIG. 5 illustrates physical channels used for the 3GPP LTE/LTE-A system to which the present invention can be applied and a general signal transmission method using the physical channels.

FIG. 6 illustrates a radio frame structure defined in the 3GPP LTE/LTE-A system to which the present invention can be applied.

FIG. 7 illustrates a resource grid corresponding to one downlink slot in a wireless communication system to which the present invention can be applied.

FIG. 8 illustrates a structure of a downlink subframe in a wireless communication system to which the present invention can be applied.

FIG. 9 illustrates a structure of an uplink subframe in a wireless communication system to which the present invention can be applied.

FIG. 10 is a flowchart showing an RRC connection establishment procedure to which the present invention can be applied.

FIG. 11 is a flowchart showing an RRC connection reconfiguration procedure to which the present invention can be applied.

FIG. 12 illustrates a format of an MAC control element for reporting a buffer state in a wireless communication system to which the present invention can be applied.

FIG. 13 illustrates one example of a component carrier and carrier aggregation in a wireless communication system to which the present invention can be applied.

FIG. 14 illustrates a contention-based random access procedure in a wireless communication system to which the present invention can be applied.

FIG. 15 illustrates a non-contention based random access procedure in a wireless communication system to which the present invention can be applied.

FIG. 16 illustrates latency required for each process of a contention-based random access procedure required by the 3GPP LTE-A system to which the present invention can be applied.

FIG. 17 illustrates one example of a random access procedure in the LTE system.

FIGS. 18 to 21 illustrate one example of a time period required for a mobile terminal to obtain resources allocated by a base station and to transmit a uplink message.

FIG. 22 illustrates one example of transmitting uplink data through feedback information to which the present invention can be applied.

FIGS. 23 to 25 illustrate one example of a feedback channel through which feedback information to which the present invention can be applied is transmitted.

FIG. 26 is a flow diagram illustrating one example of transmitting uplink data through feedback information to which the present invention can be applied.

FIGS. 27 to 30 illustrate one example of determining a method for transmitting uplink data according to feedback information to which the present invention can be applied.

FIGS. 31 to 33 illustrate one example of transmission time of a uplink message according to the present invention.

FIG. 34 illustrates one example of an internal block diagram of a wireless device to which the present invention can be applied.

### DETAILED DESCRIPTION OF THE INVENTION

Reference will now be made in detail to the preferred embodiments of the present invention, examples of which are illustrated in the accompanying drawings. The detailed description set forth below in connection with the appended drawings is a description of exemplary embodiments and is not intended to represent the only embodiments through which the concepts explained in these embodiments can be practiced. The detailed description includes details for the purpose of providing an understanding of the present invention. However, it will be apparent to those skilled in the art that these teachings may be implemented and practiced without these specific details.

In some instances, known structures and devices are omitted, or are shown in block diagram form focusing on important features of the structures and devices, so as not to obscure the concept of the present invention.

In the embodiments of the present invention, a message, frame, a signal, field and a apparatus are not limited to each of the names as for the purpose of explaining the invention, and may be replaced with a other message, other frame, a other signal, other field and a other apparatus that performs the same function.

In the embodiments of the present invention, the enhanced Node B (eNode B or eNB) may be a terminal node of a network, which directly communicates with the terminal. In some cases, a specific operation described as performed by the eNB may be performed by an upper node of the eNB. Namely, it is apparent that, in a network comprised of a plurality of network nodes including an eNB, various operations performed for communication with a terminal may be performed by the eNB, or network nodes other than the eNB. The term ‘eNB’ may be replaced with the term ‘fixed station’, ‘base station (BS)’, ‘Node B’, ‘base transceiver system (BTS),’, ‘access point (AP)’, ‘MeNB(Macro eNB)’, ‘SeNB(Secondary eNB)’ etc. The term ‘user equipment (UE)’ may be replaced with the term ‘terminal’, ‘mobile station (MS)’, ‘user terminal (UT)’, ‘mobile subscriber station (MSS)’, ‘subscriber station (SS)’, ‘Advanced Mobile Station (AMS)’, ‘Wireless terminal (WT)’, ‘Machine-Type Communication (MTC) device’, ‘Machine-to-Machine (M2M) device’, ‘Device-to-Device (D2D) device’, wireless device, etc.

In the embodiments of the present invention, “downlink (DL)” refers to communication from the eNB to the UE, and “uplink (UL)” refers to communication from the UE to the eNB. In the downlink, transmitter may be a part of eNB, and receiver may be part of UE. In the uplink, transmitter may be a part of UE, and receiver may be part of eNB.

Specific terms used for the embodiments of the present invention are provided to aid in understanding of the present invention. These specific terms may be replaced with other terms within the scope and spirit of the present invention.

The embodiments of the present invention can be supported by standard documents disclosed for at least one of wireless access systems, Institute of Electrical and Electronics Engineers (IEEE) 802, 3rd Generation Partnership Project (3GPP), 3GPP Long Term Evolution (3GPP LTE), LTE-Advanced (LTE-A), and 3GPP2. Steps or parts that are not described to clarify the technical features of the present invention can be supported by those documents. Further, all terms as set forth herein can be explained by the standard documents.

Techniques described herein can be used in various wireless access systems such as Code Division Multiple Access (CDMA), Frequency Division Multiple Access (FDMA), Time Division Multiple Access (TDMA), Orthogonal Frequency Division Multiple Access (OFDMA), Single Carrier-Frequency Division Multiple Access (SC-FDMA), ‘non-orthogonal multiple access (NOMA)’, etc. CDMA may be implemented as a radio technology such as Universal Terrestrial Radio Access (UTRA) or CDMA2000. TDMA may be implemented as a radio technology such as Global System for Mobile communications (GSM)/General Packet Radio Service (GPRS)/Enhanced Data Rates for GSM Evolution (EDGE). OFDMA may be implemented as a radio technology such as IEEE 802.11 (Wi-Fi), IEEE 802.16 (WiMAX), IEEE 802.20, Evolved-UTRA (E-UTRA) etc. UTRA is a part of Universal Mobile Telecommunication System (UMTS). 3GPP LTE is a part of Evolved UMTS (E-UMTS) using E-UTRA. 3GPP LTE employs OFDMA for downlink and SC-FDMA for uplink. LTE-A is an evolution of 3GPP LTE.

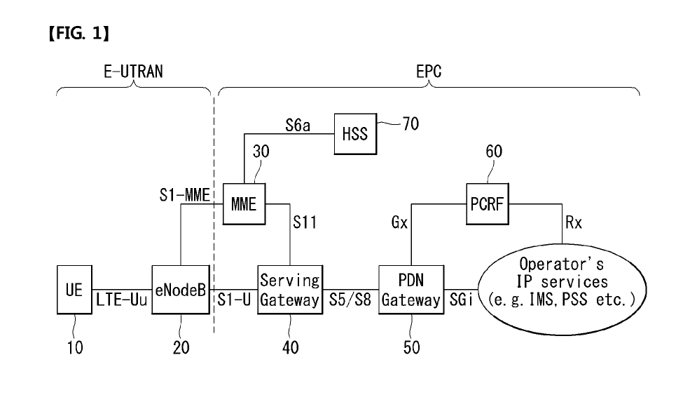

FIG. 1 is a view illustrating an Evolved Packet System which is associated with the Long Term Evolution (LTE) system to which the present invention can be applied.

The LTE system aims to provide seamless Internet Protocol (IP) connectivity between a user equipment (UE, 10) and a pack data network (PDN), without any disruption to the end user's application during mobility. While the LTE system encompasses the evolution of the radio access through an E-UTRAN (Evolved Universal Terrestrial Radio Access Network) which defines a radio protocol architecture between a user equipment and a base station(20), it is accompanied by an evolution of the non-radio aspects under the term ‘System Architecture Evolution’ (SAE) which includes an Evolved Packet Core (EPC) network. The LTE and SAE comprise the Evolved Packet System (EPS).

The EPS uses the concept of EPS bearers to route IP traffic from a gateway in the PDN to the UE. A bearer is an IP packet flow with a specific Quality of Service (QoS) between the gateway and the UE. The E-UTRAN and EPC together set up and release the bearers as required by applications.

The EPC, which is also referred to as the core network (CN), controls the UE and manages establishment of the bearers. As depicted in FIG. 1, the node (logical or physical) of the EPC in the SAE includes a Mobility Management Entity (MME) 30, a PDN gateway (PDN-GW or P-GW) 50, a Serving Gateway (S-GW) 40, a Policy and Charging Rules Function (PCRF) 40, a Home subscriber Server (HSS) 70, etc.

The MME 30 is the control node which processes the signaling between the UE and the CN. The protocols running between the UE and the CN are known as the Non-Access Stratum (NAS) protocols. Examples of functions supported by the MME 30 includes functions related to bearer management, which includes the establishment, maintenance and release of the bearers and is handled by the session management layer in the NAS protocol, and functions related to connection management, which includes the establishment of the connection and security between the network and UE, and is handled by the connection or mobility management layer in the NAS protocol layer.

In the present invention, the MME 30 corresponds to an entity in which a function necessary to process authentication of the UE and context information is implemented, where the MME 30 is described as one embodiment of the entity. Therefore, other devices in addition to the MME 30 can also carry out the corresponding function.

The S-GW 40 serves as the local mobility anchor for the data bearers when the UE moves between eNodeBs. All user IP packets are transferred through the S-GW 40. The S-GW 40 also retains information about the bearers when the UE is in idle state (known as ECM-IDLE) and temporarily buffers downlink data while the MME initiates paging of the UE to re-establish the bearers. Further, it also serves as the mobility anchor for inter-working with other 3GPP technologies such as GPRS (General Packet Radio Service) and UMTS (Universal Mobile Telecommunications System).

In the present invention, the S-GW 40 corresponds to an entity in which a function necessary for processing authentication of the UE and context information is implemented, where the S-GW 40 is described as one embodiment of the entity. Therefore, other devices in addition to the S-GW 40 can also carry out the corresponding function.

The P-GW 50 serves to perform IP address allocation for the UE, as well as QoS enforcement and flow-based charging according to rules from the PCRF 60. The P-GW 50 performs QoS enforcement for Guaranteed Bit Rate (GBR) bearers. It also serves as the mobility anchor for inter-working with non-3GPP technologies such as CDMA2000 and WiMAX networks.

In the present invention, the P-GW 50 corresponds to an entity in which a function necessary for processing routing/forwarding of user data is implemented, where the P-GW 50 is described as one embodiment of the entity. Therefore, other devices in addition to the P-GW 50 can also carry out the corresponding function.

Between the EPS network elements shown in FIG. 1, various interfaces such as an S1-U, S1-MME, S5/S8, S11, S6a, Gx, Rx and SGi are defined.

Hereinafter, the concept of mobility management (MM) and a mobility management (MM) back-off timer is explained in detail. The mobility management is a procedure to reduce the overhead in the E-UTRAN and processing in the UE. When the mobility management is performed, all UE-related information in the access network can be released during periods of data inactivity. This state can be referred to as EPS Connection Management IDLE (ECM-IDLE). The MME retains the UE context and the information about the established bearers during the idle periods.

To allow the network to contact a UE in the ECM-IDLE, the UE updates the network as to its new location whenever it moves out of its current Tracking Area (TA). This procedure is called a ‘Tracking Area Update’, and a similar procedure is also defined in a universal terrestrial radio access network (UTRAN) or GSM EDGE Radio Access Network (GERAN) system and is called a ‘Routing Area Update’. The MME serves to keep track of the user location while the UE is in the ECM-IDLE state.

When there is a need to deliver downlink data to the UE in the ECM-IDLE state, the MME transmits the paging message to all base stations (i.e., eNodeBs) in its current tracking area (TA). Thereafter, eNBs start to page the UE over the radio interface. On receipt of a paging message, the UE performs a certain procedure which results in changing the UE to ECM-CONNECTED state. This procedure is called a ‘Service Request Procedure’. UP-related information is thereby created in the E-UTRAN, and the bearers are re-established. The MME is responsible for the re-establishment of the radio bearers and updating the UE context in the eNodeB.

When the above-explained mobility management (MM) is applied, a mobility management (MM) back-off timer can be further used. In particular, the UE may transmit a Tracking Area Update (TAU) to update the TA, and the MME may reject the TAU request due to core network congestion, with a time value associated with the MM back-off timer. Upon receipt of the time value, the UE may activate the MM back-off timer.

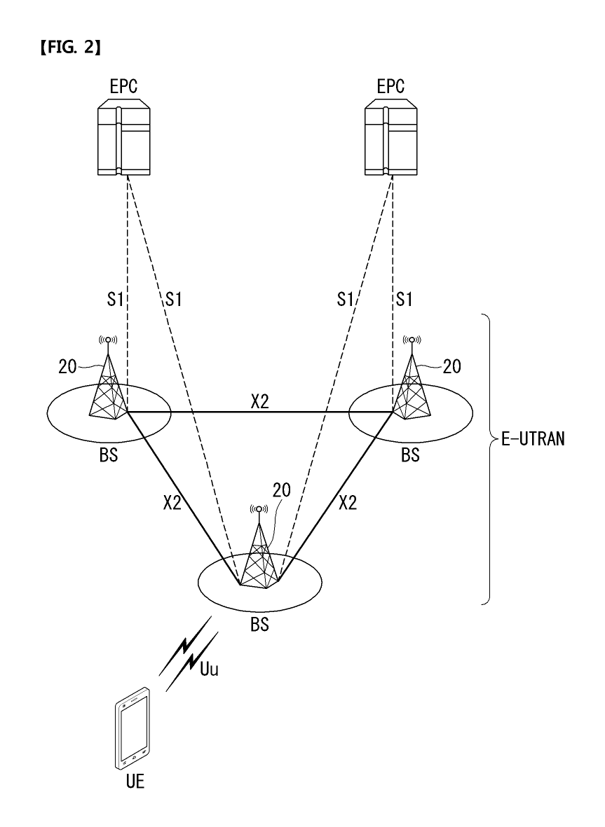

FIG. 2 illustrates a wireless communication system to which the present invention is applied. The wireless communication system may also be referred to as an evolved-UMTS terrestrial radio access network (E-UTRAN) or a long term evolution (LTE)/LTE-A system.

The E-UTRAN includes at least one base station (BS) 20 which provides a control plane and a user plane to a user equipment (UE) 10. The UE 10 may be fixed or mobile, and may be referred to as another terminology, such as a mobile station (MS), a user terminal (UT), a subscriber station (SS), a mobile terminal (MT), a wireless device, etc. The BS 20 is generally a fixed station that communicates with the UE 10 and may be referred to as another terminology, such as an evolved node-B (eNB), a base transceiver system (BTS), an access point, etc.

The BSs 20 are interconnected by means of an X2 interface. The BSs 20 are also connected by means of an S1 interface to an evolved packet core (EPC), more specifically, to a mobility management entity (MME) through S1-MME and to a serving gateway (S-GW) through S1-U.

The EPC includes an MME, an S-GW, and a packet data network-gateway (P-GW). The MME has access information of the UE or capability information of the UE, and such information is generally used for mobility management of the UE. The S-GW is a gateway having an E-UTRAN as an end point. The P-GW is a gateway having a PDN as an end point.

Layers of a radio interface protocol between the UE and the network can be classified into a first layer (L1), a second layer (L2), and a third layer (L3) based on the lower three layers of the open system interconnection (OSI) model that is well-known in the communication system. Among them, a physical (PHY) layer belonging to the first layer provides an information transfer service by using a physical channel, and a radio resource control (RRC) layer belonging to the third layer serves to control a radio resource between the UE and the network. For this, the RRC layer exchanges an RRC message between the UE and the BS.

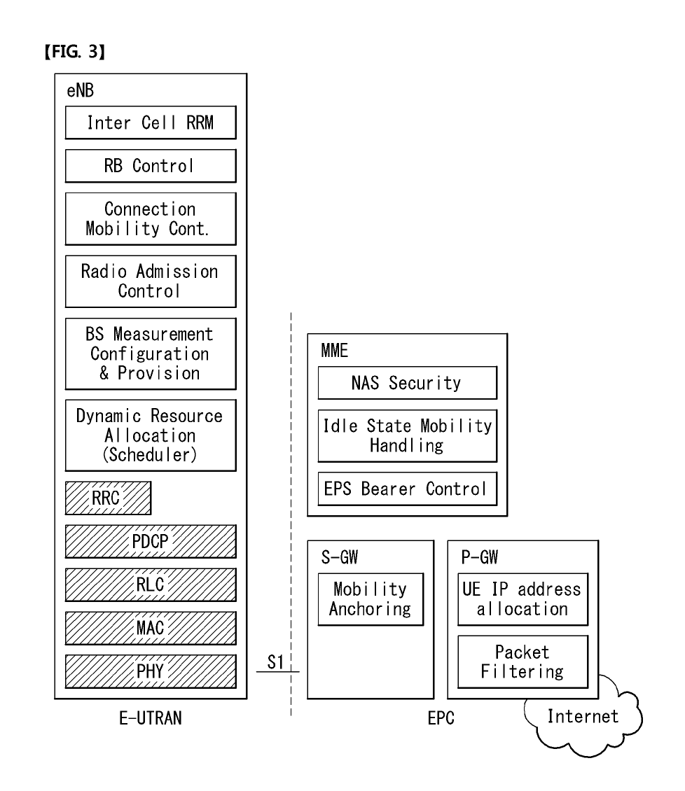

FIG. 3 illustrates a functional split of an E-UTRAN and an EPC to which the present invention can be applied.

Referring to the FIG. 3, the eNB may perform functions of selection for the gateway (for example, MME), routing toward the gateway during a radio resource control (RRC) activation, scheduling and transmitting of paging messages, scheduling and transmitting of broadcast channel (BCH) information, dynamic allocation of resources to the UEs in both uplink and downlink, configuration and provisioning of eNB measurements, radio bearer control, radio admission control (RAC), and connection mobility control in LTE_ACTIVE state. In the EPC, and as mentioned above, the gateway may perform functions of paging origination, LTE_IDLE state management, ciphering of the user plane, System Architecture Evolution (SAE) bearer control, and ciphering and integrity protection of NAS signaling.

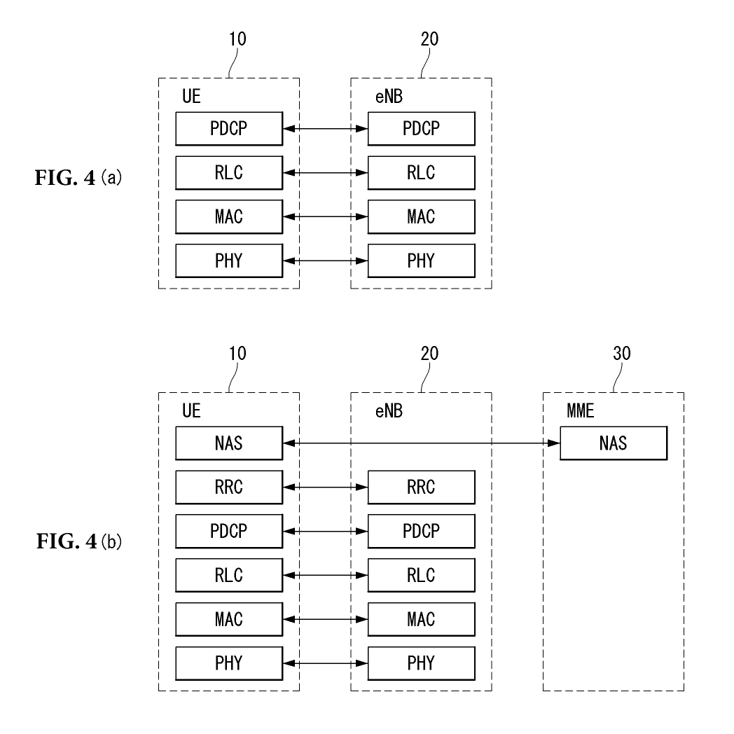

FIG. 4(a) is a diagram illustrating a radio protocol architecture for a user plane. FIG. 4(b) is a diagram illustrating a radio protocol architecture for a control plane. The user plane is a protocol stack for user data transmission. The control plane is a protocol stack for control signal transmission.

Referring to FIGS. 4(a) and 4(b), a PHY layer provides an upper layer with an information transfer service through a physical channel. The PHY layer is connected to a medium access control (MAC) layer which is an upper layer of the PHY layer through a transport channel. Data is transferred between the MAC layer and the PHY layer through the transport channel. The transport channel is classified according to how and with what characteristics data is transmitted through a radio interface.

Between different PHY layers, i.e., a PHY layer of a transmitter and a PHY layer of a receiver, data are transferred through the physical channel. The physical channel is modulated using an orthogonal frequency division multiplexing (OFDM) scheme, and utilizes time and frequency as a radio resource.

A function of the MAC layer includes mapping between a logical channel and a transport channel and multiplexing/de-multiplexing on a transport block provided to a physical channel over a transport channel of a MAC service data unit (SDU) belonging to the logical channel. The MAC layer provides a service to a radio link control (RLC) layer through the logical channel.

A function of the RLC layer includes RLC SDU concatenation, segmentation, and reassembly. To ensure a variety of quality of service (QoS) required by a radio bearer (RB), the RLC layer provides three operation modes, i.e., a transparent mode (TM), an unacknowledged mode (UM), and an acknowledged mode (AM). The AM RLC provides error correction by using an automatic repeat request (ARQ).

Functions of a packet data convergence protocol (PDCP) layer in the user plane include user data delivery, header compression, and ciphering. Functions of a PDCP layer in the control plane include control-plane data delivery and ciphering/integrity protection.

A radio resource control (RRC) layer is defined only in the control plane. The RRC layer serves to control the logical channel, the transport channel, and the physical channel in association with configuration, reconfiguration and release of radio bearers (RBs). An RB is a logical path provided by the first layer (i.e., PHY layer) and the second layer (i.e., MAC layer, RLC layer, and PDCP layer) for data delivery between the UE and the network.

The configuration of the RB implies a process for specifying a radio protocol layer and channel properties to provide a specific service and for determining respective detailed parameters and operations. The RB can be classified into two types, i.e., a signaling RB (SRB) and a data RB (DRB). The SRB is used as a path for transmitting an RRC message in the control plane. The DRB is used as a path for transmitting user data in the user plane.

When an RRC connection exists between an RRC layer of the UE and an RRC layer of the network, the UE is in an RRC connected state, and otherwise the UE is in an RRC idle state.

Data are transmitted from the network to the UE through a downlink transport channel. Examples of the downlink transport channel include a broadcast channel (BCH) for transmitting system information and a downlink-shared channel (SCH) for transmitting user traffic or control messages. The user traffic of downlink multicast or broadcast services or the control messages can be transmitted on the downlink-SCH or an additional downlink multicast channel (MCH). Data are transmitted from the UE to the network through an uplink transport channel. Examples of the uplink transport channel include a random access channel (RACH) for transmitting an initial control message and an uplink SCH for transmitting user traffic or control messages.

Examples of logical channels belonging to a higher channel of the transport channel and mapped onto the transport channels include a broadcast channel (BCCH), a paging control channel (PCCH), a common control channel (CCCH), a multicast control channel (MCCH), a multicast traffic channel (MTCH), etc.

The physical channel includes several symbols in a time domain and several sub-carriers in a frequency domain. One sub-frame includes a plurality of symbols in the time domain. One subframe includes a plurality of resource blocks. One resource block includes a plurality of symbols and a plurality of sub-carriers. Further, each subframe may use specific sub-carriers of specific symbols (e.g., a first symbol) of a corresponding subframe for a physical downlink control channel (PDCCH), i.e., an L1/L2 control channel. A transmission time interval (TTI) is a unit time of data transmission, and is 1 millisecond (ms) which corresponds to one subframe.

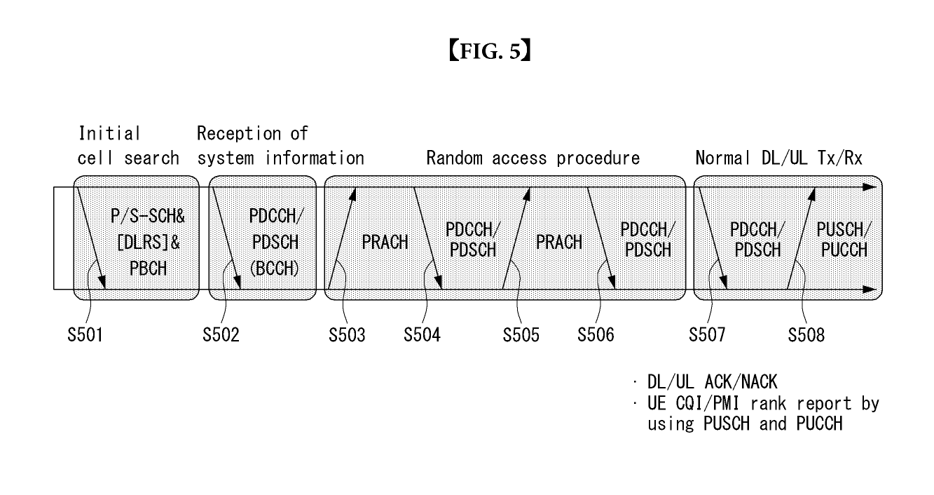

FIG. 5 illustrates physical channels used for the 3GPP LTE/LTE-A system to which the present invention can be applied and a general signal transmission method using the physical channels.

A UE, which may have been powered on again from the power-off state or may have newly entered a cell, carries out the initial cell search task such as synchronizing itself with an eNB in the S501 step. To this purpose, the UE synchronizes with the eNB by receiving a primary synchronization channel (P-SCH) and a secondary synchronization channel (S-SCH) from the eNB and obtains information such as a cell ID (identifier).

Afterwards, the UE receives a physical broadcast channel (PBCH) signal from the eNB and obtains broadcast signal within the eNB. Meanwhile, the UE receives a downlink reference signal (DL RS) in the initial cell search step to check the downlink channel status.

The UE which has finished the initial cell search receives a PDSCH according to the PDCCH and PDCCH information in the S502 step to obtain more specific system information.

Next, the UE may carry out a random access procedure such as the steps of S503 to S506 to complete a connection process to the eNB. To this purpose, the UE transmits a preamble S503 through a physical random access channel (PRACH) and receives a response message in response to the preamble through a PDSCH corresponding to the PRACH S304. In the case of contention-based random access, the UE may carry out a contention resolution procedure including transmission of an additional PRACH signal S305 and reception of a PDCCH signal and the PDSCH signal corresponding to the PDCCH signal S506.

Afterwards, the UE which has carried out the procedure above may carry out reception S507 of the PDCCH signal and/or PDSCH signal and transmission S508 of a PUSCH signal and/or a PUCCH signal as a conventional uplink/downlink signal transmission procedure.

The control information that the UE transmits to the eNB is called collectively uplink control information (UCI). The UCI includes HARQ-ACK/NACK, a scheduling request (SR), a channel quality indicator (CQI), a precoding matrix indicator (PMI), and rank indication (RI) information.

In the LTE/LTE-A system, the UCI is transmitted periodically through the PUCCH; the UCI can be transmitted through the PUSCH if control information and traffic data have to be transmitted at the same time. Also, the UCI can be transmitted non-periodically through the PUSCH according to a request or a command from the network.

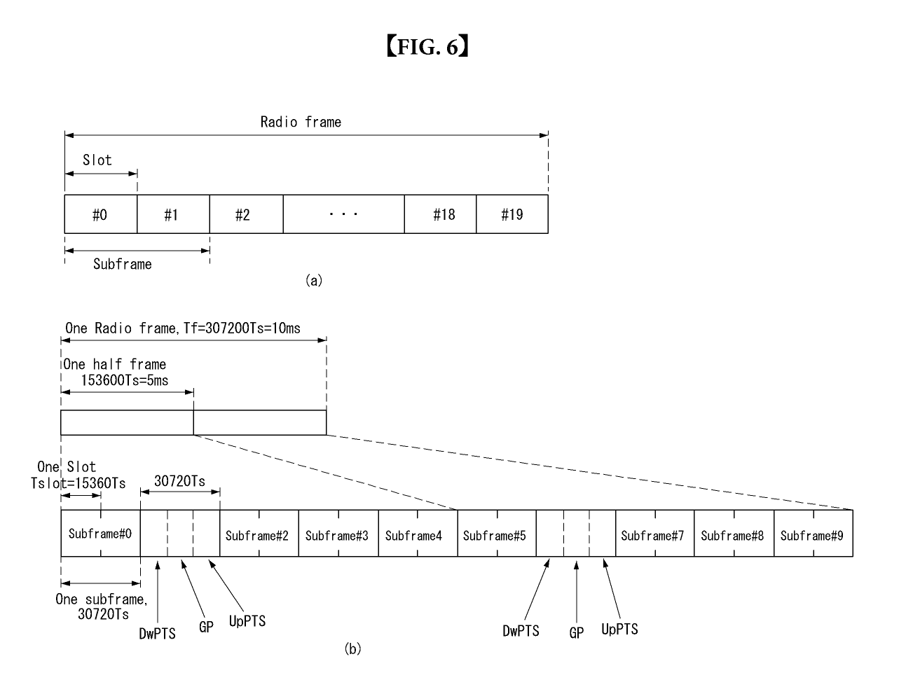

FIG. 6 illustrates a radio frame structure defined in the 3GPP LTE/LTE-A system to which the present invention can be applied.

In the cellular OFDM wireless packet communication system, transmission of uplink/downlink data packets is carried out in units of subframes, and one subframe is defined as a predetermined time period including a plurality of OFDM symbols. The 3GPP LTE/LTE-A standard supports a type 1 radio frame structure that can be applied to frequency division duplex (FDD) scheme and a type 2 radio frame structure that can be applied to time division duplex (TDD) scheme. In the FDD mode, uplink transmission and downlink transmission are carried out separately in the respective frequency bands. On the other hand, for the TDD mode, uplink and downlink transmission are carried out separately in the time domain but occupy the same frequency band. Channel responses in the TDD mode are in fact reciprocal. This implies that a downlink channel response is virtually the same as the corresponding uplink channel response in the frequency domain. Therefore, it can be regarded as an advantage for a wireless communication system operating in the TDD mode that a downlink channel response can be obtained from an uplink channel response. Since the whole frequency domain is so utilized in the TDD mode that uplink and downlink transmission are performed in time division fashion, downlink transmission by an eNB and uplink transmission by a UE cannot be performed simultaneously. In a TDD system where uplink and downlink transmission are managed in units of subframes, uplink and downlink transmission are carried out separately in the respective subframes.

FIG. 6(a) illustrates a structure of a type 1 radio frame. A downlink radio frame consists of 10 subframes, and each subframe consists of two slots in the time domain. The time period needed to transmit one subframe is called a Transmission Time Interval (TTI). For example, length of each subframe can amount to 1 ms, and length of each slot can be 0.5 ms. Each slot includes a plurality of orthogonal frequency division multiplexing (OFDM) symbols in the time domain, and includes a plurality of resource blocks (RBs) in the frequency domain. The 3GPP LTE/LTE-A system uses the OFDMA method for downlink transmission; therefore, the OFDM symbol is intended to represent one symbol period. One OFDM symbol may be regarded to correspond to one SC-FDMA symbol or a symbol period. The resource block as a unit for allocating resources includes a plurality of consecutive subcarriers within one slot.

The number of OFDM symbols included within one slot can be varied according to the configuration of a cyclic prefix. The CP has an extended CP and a normal CP. For example, in case the OFDM symbol consists of normal CPs, the number of OFDM symbols included within one slot can be 7. In case the OFDM symbol consists of extended CPs, the number of OFDM symbols included within one slot becomes smaller than that for the normal CP case since the length of a single OFDM is increased. In the case of extended CP, for example, the number of OFDM symbols included within one slot can be 6. In case a channel condition is unstable as observed when the UE moves with a high speed, the extended CP can be used to further reduce inter-symbol interference.

Since each slot consists of 7 OFDM symbols when a normal CP is used, one subframe includes 14 OFDM symbols. At this time, the first maximum 3 OFDM symbols of each subframe are allocated to the physical downlink control channel (PDCCH) and the remaining OFDM symbols are allocated to the physical downlink shared channel (PDSCH).

FIG. 6(b) illustrates a type 2 radio frame. The type 2 radio frame consists of two half frames, and each half frame consists of 5 subframes, and each subframe consists of two slots. Among the 5 subframes, a special subframe consists of a downlink pilot time slot (DwPTS), a guard period (GP), and an uplink pilot time slot (UpPTS). The DwPTS is used for the UE to carry out the initial cell search, synchronization, and channel estimation. The UpPTS is used for the eNB to carry out channel estimation and uplink transmission synchronization with the UE. The GP is a period intended for removing interference generated during uplink transmission due to multi-path delay of a downlink signal between uplink and downlink transmission.

The structure of a radio frame described above is just an example, and the number of subframes included within one radio frame, the number of slots included within one subframe, and the number of symbols included within one slot can be varied in many ways.

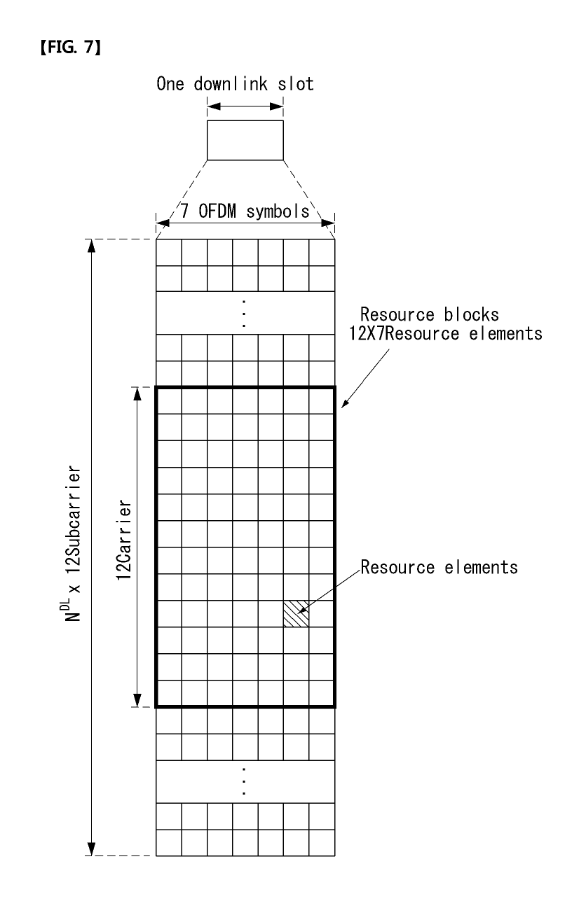

FIG. 7 illustrates a resource grid corresponding to one downlink slot in a wireless communication system to which the present invention can be applied.

With reference to FIG. 7, one downlink slot includes a plurality of OFDM symbols in the time domain. Each downlink slot includes 7 OFDM symbols, and each resource block includes 12 subcarriers in the frequency domain. However, the present invention is not limited to the illustrative configuration.

Each element of resource grids is called a resource element, and a resource block includes 12×7 resource elements. Each resource element in the resource grids can be identified by an index pair (k, l) within a slot. Here, k (k=0, . . . , NRB×12-1) stands for a subcarrier index in the frequency domain while l (l=0, . . . ,6) an OFDM symbol index in the time domain. The number NRB of resource blocks included in a downlink slot is dependent on downlink transmission bandwidth. The structure of an uplink slot can be the same as that of the downlink slot.

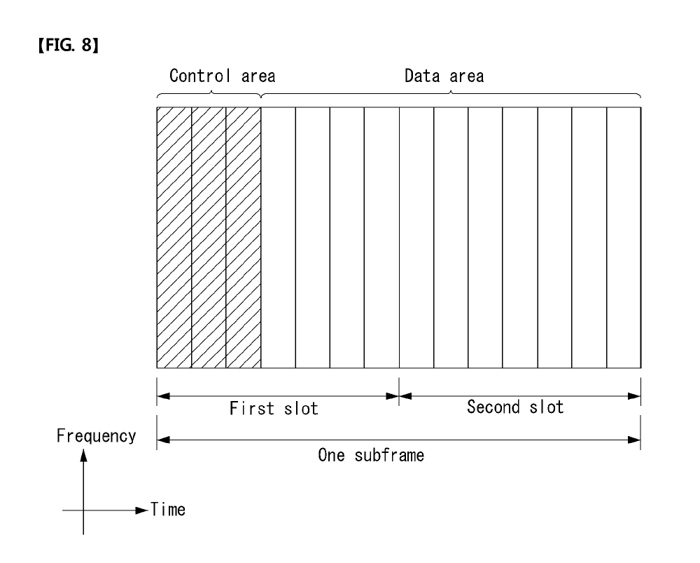

FIG. 8 illustrates a structure of a downlink subframe in a wireless communication system to which the present invention can be applied.

With reference to FIG. 8, in the first slot within a subframe, the first maximum three OFDM symbols make up a control region to which control channels are allocated, and the remaining OFDM symbols form a data region to which a PDSCH is allocated. The 3GPP LTE/LTE-A standard defines PCFICH, PDCCH, and PHICH as downlink control channels.

The PCFICH is transmitted from the first OFDM symbol of a subframe and carries information about the number (namely, size of the control region) of OFDM symbols used for transmission of control channels within a subframe. The PHICH is a response channel corresponding to an uplink and carries a ACK/NACK signal corresponding to HARQ. The control information transmitted through the PDCCH is called downlink control information (DCI). The DCI includes uplink resource allocation information, downlink resource allocation information, or uplink transmission (Tx) power control commands for an arbitrary UE group.

An eNB determines the PDCCH format according to Downlink Control Information (DCI) to be sent to a UE and adds a Cyclic Redundancy Check (CRC) to the control information. The CRC is masked with a unique identifier depending on an owner of the PDCCH or intended use of the PDCCH, which is called a Radio Network Temporary Identifier (RNTI). In the case of a PDCCH intended for a particular UE, a unique identifier for the UE, for example, Cell-RNTI (C-RNTI) can be masked with the CRC. Similarly, the CRC can be masked with a paging identifier, for example, Paging-RNTI (P-RNTI) in the case of a PDCCH intended for a paging message. The CRC can be masked with a system information identifier, for example, System Information-RNTI (SI-RNTI) in the case of a PDCCH intended for system information block. The CRC can be masked with a Random Access-RNTI (RA-RNTI) to designate a random access response in response to transmission of a random access preamble of the UE.

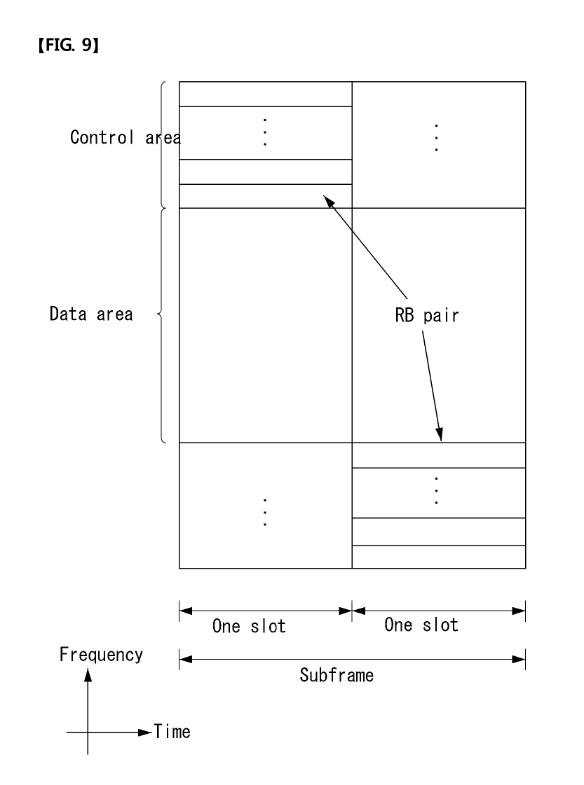

FIG. 9 illustrates a structure of an uplink subframe in a wireless communication system to which the present invention can be applied.

With reference to FIG. 9, an uplink subframe is divided into a control region and a data region in the frequency domain. A PUCCH which carries uplink control information is allocated to the control region. A PUSCH which carries data is allocated to the data region. If an upper layer commands, the UE can support the PUSCH and the PUCCH at the same time. A resource block pair is allocated within a subframe for the PUCCH of each UE. The resource blocks belonging to a resource block pair allocated to the PUCCH occupy different subcarriers at each of two slots based on a slot boundary. In this case, the resource block pair allocated to the PUCCH is said to perform frequency hopping at slot boundaries.

Physical Downlink Control Channel (PDCCH)

The control information transmitted through a PDCCH is called downlink control indicator (DCI). The size and use of the control information transmitted through the PDCCH vary according to the DCI format, and the size can still be changed according to a coding rate.

Table 1 shows the DCI according to the DCI format.

TABLE 1

| DCI | |
|---|---|
| format | Objectives |
| 0 | Scheduling of PUSCH |
| 1 | Scheduling of one PDSCH codeword |
| 1A | Compact scheduling of one PDSCH codeword |
| 1B | Closed-loop single-rank transmission |
| 1C | Paging, RACH response and dynamic BCCH |
| 1D | MU-MIMO |
| 2 | Scheduling of rank-adapted closed-loop spatial |
| | multiplexing mode |
| 2A | Scheduling of rank-adapted open-loop spatial |
| | multiplexing mode |
| 3 | TPC commands for PUCCH and PUSCH with 2 bit power |
| | adjustments |
| 3A | TPC commands for PUCCH and PUSCH with single bit |
| | power adjustments |
| 4 | the scheduling of PUSCH in one UL cell with multi- |
| | antenna port transmission mode |

With reference to Table 1, each value of the DCI format indicates the following objective: format 0 for scheduling of PUSCH, format 1 for scheduling of one PDSCH codeword, format 1A for compact scheduling of one PDSCH codeword, format 1C for very compact scheduling of DL-SCH, format 2 for PDSCH scheduling in a closed-loop spatial multiplexing mode, format 2A for PDSCH scheduling in an open loop spatial multiplexing mode, format 3 and 3A for transmission of transmission power control (TPC) command for an uplink channel, and format 4 for PUSCH scheduling within one uplink cell in a multi-antenna port transmission mode.

The DCI format 1A can be used for PDSCH scheduling no matter what transmission mode is applied.

The DCI format can be applied separately for each UE, and PDCCHs for multiple UEs can be multiplexed within one subframe. A PDCCH is formed by aggregation of one or a few consecutive control channel elements (CCEs). A CCE is a logical allocation unit used for providing a PDCCH with a coding rate according to the state of a radio channel. One REG comprises four REs, and one CCE comprises nine REGs. To form one PDCCH, {1, 2, 4, 8} CCEs can be used, and each element of the set {1, 2, 4, 8} is called a CCE aggregation level. The number of CCEs used for transmission of a particular PDCCCH is determined by the eNB according to the channel condition. The PDCCH established according to each UE is mapped being interleaved to the control channel region of each subframe according to a CCE-to-RE mapping rule. The position of the PDCCH can be varied according to the number of OFDM symbols for a control channel of each subframe, the number of PHICH groups, transmission antenna, and frequency transition.

As described above, channel coding is applied independently to the PDCCH of each of the multiplexed UEs, and cyclic redundancy check (CRC) is applied. The CRC is masked with a unique identifier (ID) of each UE so that the UE can receive its PDCCH. However, the eNB does not inform the UE about the position of the corresponding PDCCH in the control region allocated within a subframe. Since the UE is unable to get information about from which position and at which CCE aggregation level or in which DCI format the UE's PDCCH is transmitted to receive a control channel transmitted from the eNB, the UE searches for its PDCCH by monitoring a set of PDCCH candidates within the subframe. The above operation is called blind decoding (BD). Blind decoding can be also called blind detection or blind search. The blind decoding refers to the method with which the UE demasks the UE ID in the CRC section and checks any CRC error to determine whether the corresponding PDCCH is the UE's control channel.

In what follows, described will be the information transmitted through the DCI format 0.

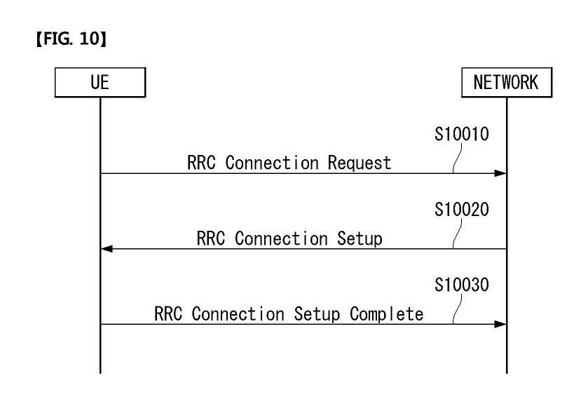

FIG. 10 is a flowchart showing an RRC connection establishment procedure to which the present invention can be applied.

A UE sends to a network an RRC connection request message for requesting an RRC connection (step S1010). The network sends an RRC connection setup message in response to the RRC connection request (step S1020). After receiving the RRC connection setup message, the UE enters an RRC connection mode.

The UE sends to the network an RRC connection setup complete message used to confirm successful completion of the RRC connection establishment (step S830).

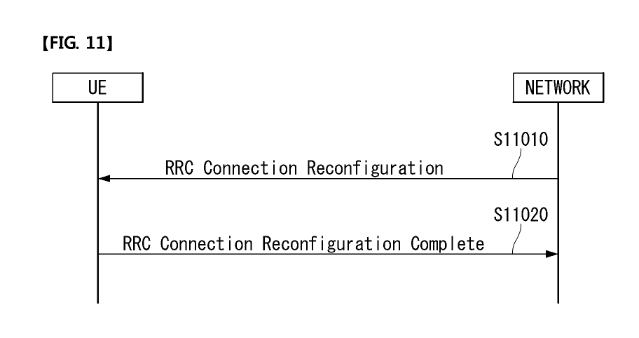

FIG. 11 is a flowchart showing an RRC connection reconfiguration procedure. An RRC connection reconfiguration is used to modify an RRC connection. This is used to establish/modify/release an RB, to perform a handover, and to set up/modify/release a measurement.

A network sends to a UE an RRC connection reconfiguration message for modifying the RRC connection (step S1110). In response to the RRC connection reconfiguration, the UE sends to the network an RRC connection reconfiguration complete message used to confirm successful completion of the RRC connection reconfiguration (step S1120).

Buffer Status Reporting (BSR)

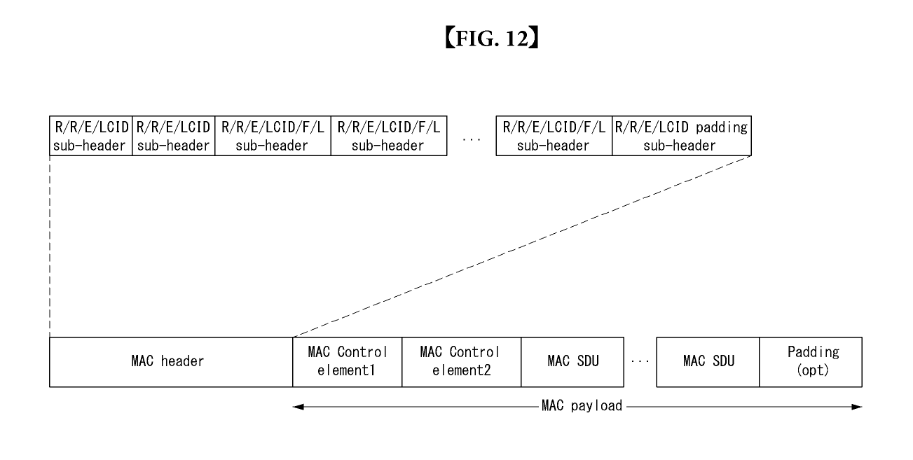

FIG. 12 illustrates an MAC PDU used by an MAC entity in a wireless communication system to which the present invention can be applied.

With reference to FIG. 12, the MAC PDU includes an MAC header, at least one MAC service data unit (SDU), and at least one MAC control element; and may further comprise padding. Depending on the situation, at least one of the MAC SDU and the MAC control element may not be included in the MAC PDU.

As shown in FIG. 12, the MAC control element usually precedes the MAC SDU. And the size of the MAC control element can be fixed or varied. In case the size of the MAC control element is variable, whether the size of the MAC control element has been increased can be determined through an extended bit. The size of the MAC SDU can also be varied.

The MAC header can include at least one or more sub-headers. At this time, at least one or more sub-headers included in the MAC header correspond to the MAC SDU, MAC control element, and padding, respectively, which the order of the sub-headers is the same as the disposition order of the corresponding elements. For example, as shown in FIG. 10, if the MAC PDU includes an MAC control element 1, an MAC control element 2, a plurality of MAC SDUs, and padding, sub-headers can be disposed in the MAC header so that a sub-header corresponding to the MAC control element 1, a sub-header corresponding to the MAC control element 2, a plurality of sub-headers corresponding respectively to the plurality of MAC SDUs, and a sub-header corresponding to padding can be disposed according to the corresponding order.

The sub-header included in the MAC header, as shown in FIG. 12, can include 6 header fields. More specifically, the sub-header can include 6 header fields of R/R/E/LCID/F/L.

As shown in FIG. 12, for the sub-header corresponding to the MAC control element of a fixed size and the sub-header corresponding to the last one among the data fields included in the MAC PDU, sub-headers including 4 header fields can be used. Therefore, in case a sub-header includes 4 fields, the four fields can be R/R/E/LCID.

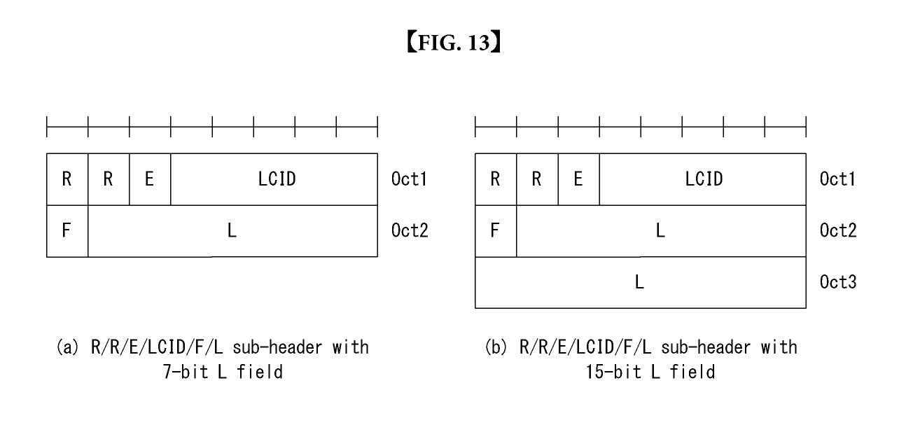

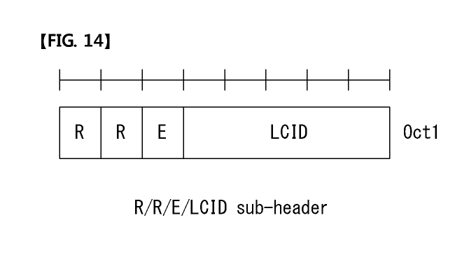

FIGS. 13 and 14 illustrate a sub-header of an MAC PDU in a wireless communication system to which the present invention can be applied.

In the following, each field is described with reference to FIGS. 13 and 14.

1) R: Reserved bit, not used.

2) E: Extended bit, indicating whether the element corresponding to a sub-header is extended. For example, if E field is ‘0’, the element corresponding to the sub-header is terminated without repetition; if E field is ‘1’, the element corresponding to the sub-header is repeated one more time and the length of the element is increased twice of the original length.

3) LCID: Logical Channel Identification. This field is used for identifying a logical channel corresponding to the MAC SDU or identifying the corresponding MAC control element and padding type. If the MAC SDU is related to a sub-header, this field then indicates a logical channel which the MAC SDU corresponds to. If the MAC control element is related to a sub-header, then this field can describe what the MAC control element is like.

Table 2 shows the LCID values for DL-SCH.

TABLE 2

| Index | LCID values |
|---|---|
| 00000 | CCCH |
| 00001-01010 | Identity of the logical channel |
| 01011-11001 | Reserved |
| 11010 | Long DRX Command |
| 11011 | Activation/Deactivation |
| 11100 | UE Contention Resolution Identity |
| 11101 | Timing Advance Command |
| 11110 | DRX Command |
| 11111 | Padding |

Table 3 shows LCID values for UL-SCH.

TABLE 3

| Index | LCID values |
|---|---|
| 00000 | CCCH |
| 00001-01010 | Identity of the logical channel |
| 01011-11000 | Reserved |
| 11001 | Extended Power Headroom Report |
| 11010 | Power Headroom Report |
| 11011 | C-RNTI |
| 11100 | Truncated BSR |
| 11101 | Short BSR |
| 11110 | Long BSR |
| 11111 | Padding |

In the LTE/LTE-A system, a UE can report its buffer state to the network by setting an index value for any of a truncated BSR in the LCID field, a short BSR, and a long BSR.

The index values and a mapping relationship of the LCID values of Tables 13 and 14 are shown for an illustrative purpose, and the present invention is not limited to the example.

4) F: Format field. Represents the size of the L field

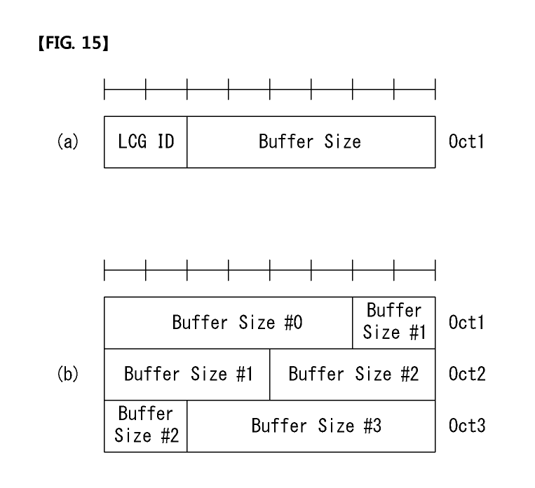

5) L: Length field. Represents the size of the MAC SDU corresponding to a sub-header and the size of the MAC control element. If the size of the MAC SDU corresponding to a sub-header or the size of the MAC control element is equal to or smaller than 127 bits, 7 bits of the L field can be used (FIG. 13(a)) and 15 bits of the L field can be used for the other cases (FIG. 13(b)). In case the size of the MAC control element varies, the size of the MAC control element can be defined through the L field. In case the size of the MAC control element is fixed, the F and the L field may be omitted as shown in FIG. 15 since the size of the MAC control element can be determined without defining the size of the MAC control element through the L field.

FIG. 15 illustrates a format of an MAC control element for reporting a buffer state in a wireless communication system to which the present invention can be applied.

In case the truncated BSR and short BSR are defined in the LCID field, the MAC control element corresponding to a sub-header can be configured to include a logical channel group identification (LCG ID) field and a buffer size field indicating a buffer state of the logical channel group as shown in FIG. 15(a). The LCG ID field is intended to identify a logical channel group to which to report a buffer state and can have the size of two bits.

The buffer size field is intended to identify the total amount of data available for all of the logical channels belonging to a logical channel group after the MAC PDU is created. The available data include all of the data that can be transmitted from the RLC layer and the PDCP layer, and the amount of data is represented by the number of bytes. The buffer size field can have the size of 6 bits.

In case a long BSR is defined for the LCID field of a sub-header, the MAC control element corresponding to a sub-header can include 4 buffer size fields indicating buffer states of the four groups having LCG IDs ranging from 0 to 3 as shown in FIG. 15(b). Each buffer size field can be used to identify the total amount of data available for each logical channel group.

Uplink Resource Allocation Procedure

In the case of the 3GPP LTE/LTE-A system, a method for data transmission and reception based on scheduling of an eNB is used to maximize utilization of radio resources. This again implies that in case a UE has data to transmit, the UE requests the eNB to allocate uplink resources in the first place and is capable of transmitting data by using only the uplink resources allocated by the eNB.

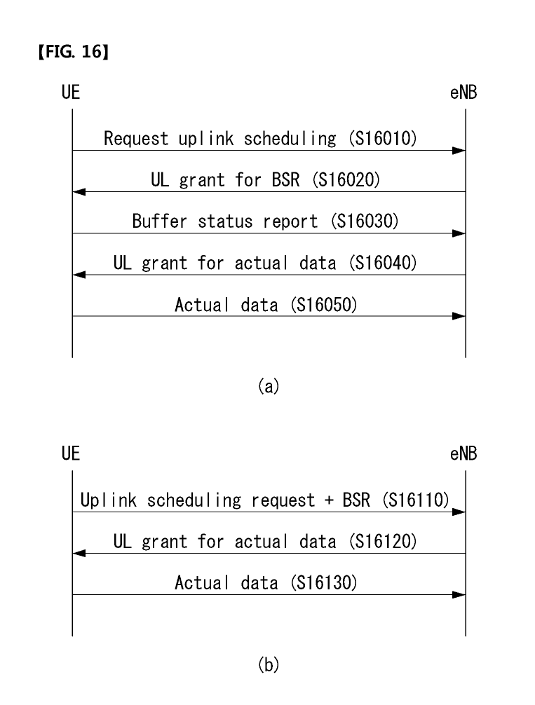

FIG. 16 illustrates an uplink resource allocation process of a UE in a wireless communication system to which the present invention can be applied.

For efficient use of radio resources in uplink transmission, an eNB needs to know which data and how much of the data to transmit to each UE. Therefore, the UE transmits to the eNB the information about uplink data that the UE attempts to transmit directly, and the eNB allocates uplink resources to the corresponding UE in accordance to the UE's transmission. In this case, the information about uplink data that the UE transmits to the eNB is the amount of uplink data stored in the UE's buffer, which is called buffer status report (BSR). When radio resources on the PUSCH are allocated during a current TTI and a reporting event is triggered, the UE transmits the BSR by using the MAC control element.

FIG. 16(a) illustrates an uplink resource allocation process for actual data in case the uplink radio resources for buffer status reporting are not allocated to the UE. In other words, in the case of a UE making a transition from the DRX mode to an active mode, since no data resources are allocated beforehand, the UE has to request resources for uplink data, starting with SR transmission through the PUCCH, and in this case, an uplink resource allocation procedure of five steps is employed.

FIG. 16(a) illustrates the case where the PUSCH resources for transmitting BSR are not allocated to the UE, and the UE first of all transmits a scheduling request (SR) to the eNB to receive PUSCH resources S16010.

The scheduling request is used for the UE to request the eNB to allocate the PUSCH resources for uplink transmission in case radio resources are not scheduled on the PUSCH during a current TTI although a reporting event has occurred. In other words, when a regular BSR has been triggered but uplink radio resources for transmitting the BSR to the eNB are not allocated to the UE, the UE transmits the SR through the PUCCH. Depending on whether the PUCCH resources for SR have been configured, the UE may transmit the SR through the PUCCH or starts a random access procedure. More specifically, the PUCCH resources through the SR can be transmitted are set up by an upper layer (for example, the RRC layer) in a UE-specific manner, and the SR configuration include SR periodicity and SR sub-frame offset information.

If the UE receives from the eNB an UL grant with respect to the PUSCH resources for BSR transmission S16020, the UE transmits the BSR to the eNB, which has been triggered through the PUSCH resources allocated by the UL grant S16030.

By using the BSR, the eNB checks the amount of data for the UE to actually transmit through uplink transmission and transmits to the UE an UL grant with respect to the PUSCH resources for transmission of actual data S16040. The UE, which has received the UL grant meant for transmission of actual data, transmits to the eNB actual uplink data through the allocated PUSCH resources S16050.

FIG. 16(b) illustrates an uplink resource allocation process for actual data in case the uplink radio resources for buffer status reporting are allocated to the UE.

FIG. 16(b) illustrates the case where the PUSCH resources for BSR transmission have already been allocated to the UE; the UE transmits the BSR through the allocated PUSCH resources and transmits a scheduling request to the eNB along with the BSR transmission S16110. Next, by using the BSR, the eNB check the amount of data that the UE actually transmits through uplink transmission and transmits to the UE an UL grant with respect to the PUSCH resources for transmission of actual data S16120. The UE, which has received an UL grant for transmission of actual data, transmits actual uplink data to the eNB through the allocated PUSCH resources S16130.

Random Access Procedure (RACH)

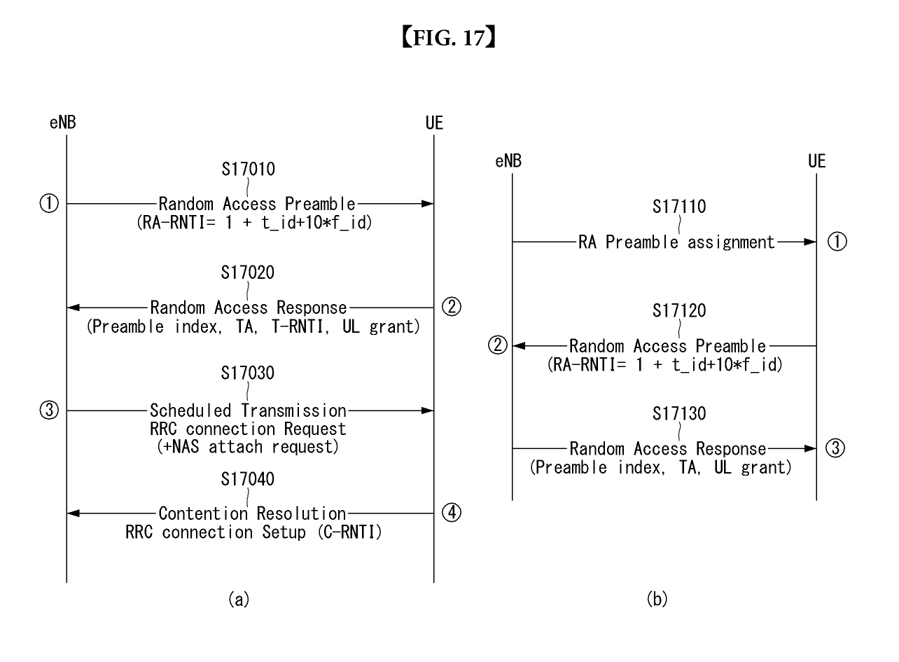

FIG. 17 illustrates one example of a random access procedure in the LTE system.

The UE carries out the random access procedure (RACH) at the time of the initial connection in the RRC_IDLE state, initial connection after radio link failure, handover requiring the RACH, and generation of uplink or downlink data requiring the RACH while in the RRC_CONNECTED state. Part of RRC messages such as the RRC connection request message, cell update message, and UTRAN Registration Area (URA) update message are also transmitted through the random access procedure. Logical channels such as Common Control Channel (CCCH), Dedicated Control Channel (DCCH), and Dedicated Traffic Channel (DTCH) can be mapped to a transmission channel RACH. A transmission channel RACH is mapped to a physical channel such as the Physical Random Access Channel (PRACH).

If the UE's MAC layer commands the UE's physical layer to start PRACH transmission, the UE's physical layer first selects one access slot and one signature to transmit the PRACH preamble to the uplink. Two types of random access procedure are defined: contention based and non-contention based random access procedure.

FIG. 17(a) illustrates one example of a contention based random access procedure, while FIG. 17(b) illustrates one example of a non-contention based random access procedure.

First, contention based random access procedure will be described with reference to FIG. 17(a).

The UE receives information about random access from the eNB through system information and stores the received information. Afterwards, in case random access is required, the UE transmits a random access preamble (which is also called a message 1) to the base station S17010.

If the eNB receives a random access preamble from the UE, the eNB transmits a random access response (which is also called a message 2) to the UE S17020. To be specific, downlink scheduling information with respect to the random access response message is CRC masked with a Random Access-Radio Network Temporary Identifier (RA-RNTI) and transmitted on the L1 or L2 control channel (PDCCH). The UE, having receiving a downlink scheduling signal masked with the RA-RNTI, receives a random access response message from a Physical Downlink Shared Channel (PDSCH) and decodes the received random access response message. Afterwards, the UE checks the random access response message whether it contains random access response information directed to the UE.

Existence of random access response information directed to the UE can be determined by checking a Random Access Preamble ID (RAID) with respect to a preamble that the UE has transmitted.

The random access response information includes Timing Alignment (TA) representing timing offset information for synchronization, allocation information of radio resources used for uplink, and a temporary C-RNTI for UE identification.

In case random access response information is received, the UE carries out uplink transmission (which is also called a message 3) to a uplink Shared Channel (SCH) according to the radio resource allocation information included in the response information. At this time, uplink transmission may be expressed as scheduled transmission.

After receiving the uplink transmission from the UE, the eNB transmits a message for contention resolution (which is also called a message 4) to the UE through a Downlink Shared Channel (DL-SCH) S17040.

Next, non-contention based random access procedure will be described with reference to FIG. 17(b).

Before the UE transmits a random access preamble, the eNB allocates a non-contention based random access preamble to the UE S17110.

The non-contention based random access preamble can be allocated through a handover command or dedicated signaling such as a PDCCH. In case a non-contention based random access preamble is allocated to the UE, the UE transmits the allocated non-contention based random access preamble to the eNB S17120.

Afterwards, the eNB is able to transmit a random access response (which is also called a message 2) to the UE similarly to the S2002 step of the contention based random access procedure S17130.

Although HARQ has not been applied to the random access response during the random access procedure above, the HARQ can be applied to uplink transmission with respect to the random access response or a message for contention resolution. Therefore, the UE doesn't necessarily have to transmit ACK or NACK with respect to the random access response.

Next, a UL data transmission method in the LTA(-A) or 802.16 system will be described briefly.

A cellular system such as the LTE(-A) or 802.16m system employs an eNB scheduling-based resource allocation method.

In a system which employs the eNB scheduling based resource allocation method, the UE with data to be transmitted (i.e., UL data) requests resources for transmission of the corresponding data from the eNB before transmitting the data.

The scheduling request of the UE can be carried out through Scheduling Request (SR) transmission to a PUCCH or Buffer Status Report (BSR) transmission to a PUSCH.

Also, in case resources used for transmitting SR or BSR are not limited to the UE, the UE can request uplink resources from the eNB through an RACH procedure.

As described above, the eNB which has received a scheduling request from the UE allocates uplink resources to be used for the corresponding UE through a downlink control channel (i.e., UL grant message or DCI in the case of the LTE(-A) system).

At this time, a UL grant transmitted to the UE may be used to inform the UE of which subframe the resources allocated to the UE correspond to through explicit signaling, but the UL grant may be used to define a predefined timing between the UE and the eNB for resource allocation with respect to a subframe after specific time (for example, 4 ms in the case of the LTE system).

As described above, the eNB's allocating resources to the UE after X ms (for example, 4 ms in the case of the LTE(-A) system) implies that the UE allocates resources by taking into account all of the time periods for the UE to receive and decode a UL grant, to prepare data to be transmitted, and to encode the prepared data.

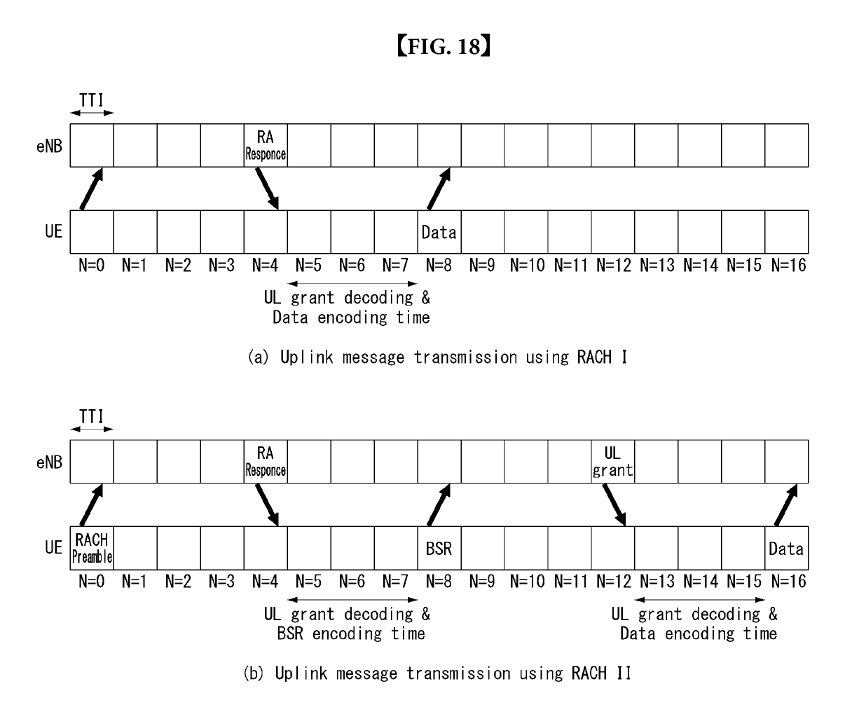

FIGS. 18 to 21 illustrate one example of a time period required for a mobile terminal to obtain resources allocated by a base station and to transmit a uplink message.

Referring to FIGS. 18 to 21, the UE requests uplink radio resources from the eNB to transmit a message and transmits the message to the eNB through the resources allocated according to the request. At this time, according to a resource allocation procedure, a transmission delay may occur as described below.

First, delays from the respective procedures will be described based on an assumption that TTI is 1 ms, the period of RACH or a Scheduling Request (SR) is 1 TTI, and waiting time of the RACH or SR is ½ TTI.

FIG. 18 illustrates a delay according to a uplink resource allocation through random access. As shown in FIG. 18(a), in case a buffer status report is not carried out, a delay of 9.5 ms occurs; while, if a buffer status is reported as shown in FIG. 18(b), a delay of 17.5 ms occurs.

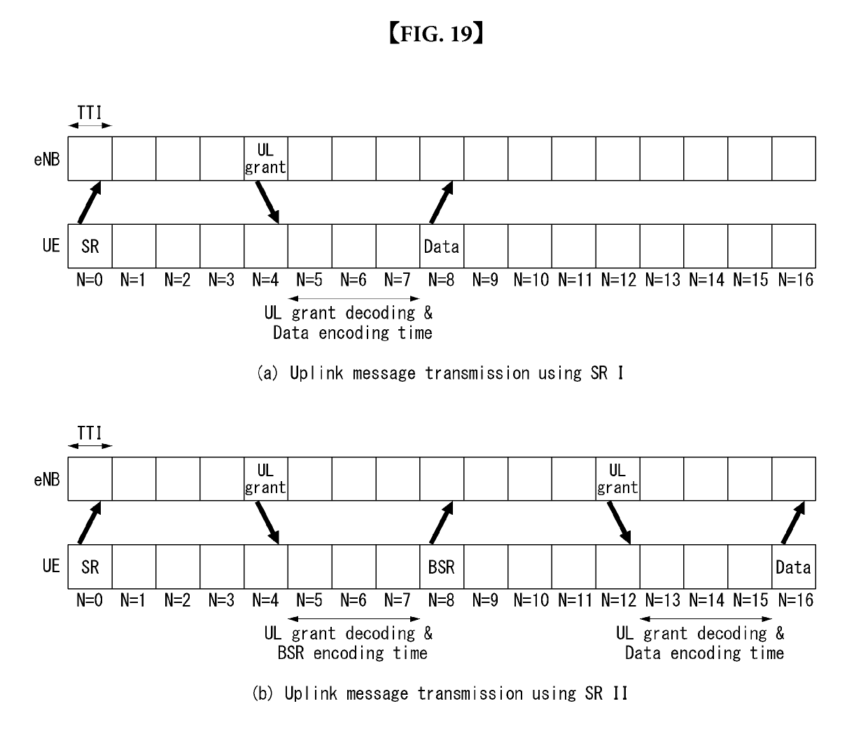

FIG. 19 illustrates a delay according to a uplink resource allocation method through Scheduling Request (SR). As shown in FIG. 19(a), in case a buffer status report is not carried out, a delay of 9.5 ms occurs, while, if a buffer status is reported as shown in FIG. 19(b), a delay of 17.5 ms occurs.

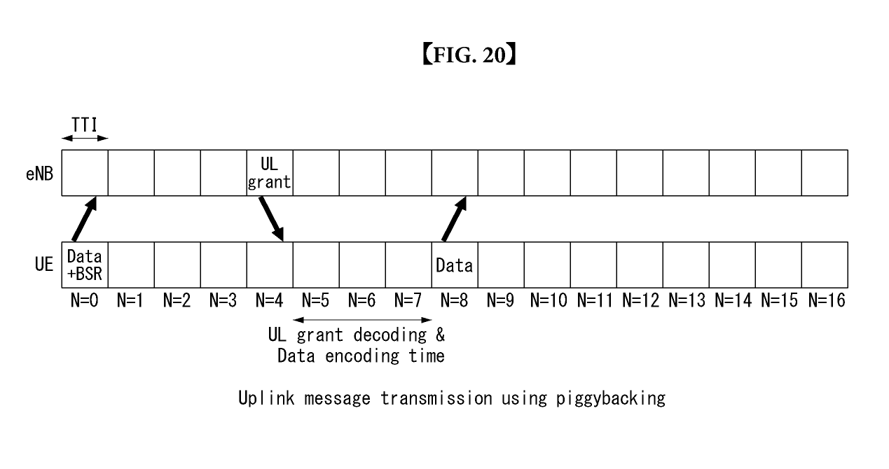

FIG. 20 illustrates a delay in the case where a uplink message is transmitted through piggybacking, where in this case, a delay of 9.5 ms occurs. As shown in FIGS. 18 to 20, in case a message is transmitted by using uplink resources allocated by the eNB, a delay ranging from 9.5 ms to 17.5 ms occurs.

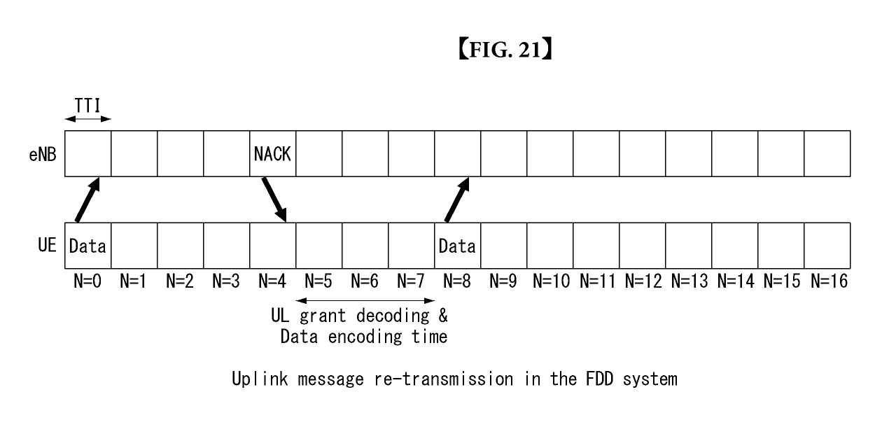

Also, as shown in FIG. 21, in case the eNB fails to receive the uplink message, the eNB transmits NACK to the UE, and the UE re-transmits the uplink message to the eNB. At this time, in case the uplink message is retransmitted, a delay of 8 ms occurs.

Recently, needs for various real-time application services such as health care, transportation safety, disaster safety, and remote medical control are emerging. In particular, in the case of a specific service which prevents a secondary accident or facilitates rapid handling of an emergency situation by quickly notifying eNBs or nearby UEs/users of information about an accident or a situation that can happen due to a particular event at unpredictable time obtained from various end users such as humans or machines (cars or sensors), the time delay during transmission of a message as described above may incur a secondary accident and prevent an emergency situation from being informed at right timing.

To solve the problem above, a delay in transmitting and receiving data has to be necessarily reduced. To this purpose, the present invention provides a method for a UE not only in a connected state but also in an idle state where a data transmission delay is approximately five times that of a UE in the connected state to transmit uplink data without using resources allocated by the eNB.

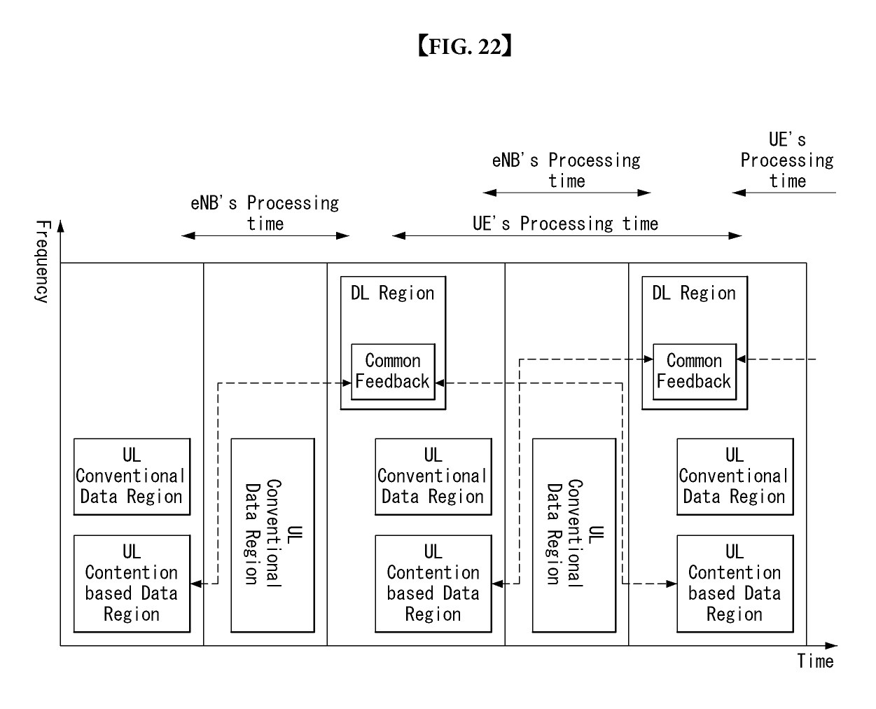

FIG. 22 illustrates one example of transmitting uplink data through feedback information to which the present invention can be applied.

With reference to FIG. 22, when a UE supporting a specific service attempts to transmit a message used to transmit data for providing a specific service (hereinafter, it is called a specific service data) (for example, a message for requesting an RRC connection, a message for requesting transmission of the specific service data, a message for transmitting the specific service, a message for RRC connection re-establishment, a message for security mode configuration, or a message for transmitting user data), the UE can transmit the message by using the resources not dedicated to a specific UE, namely, resources that can be used by other UEs.

In what follows, those resources or channels not limited to a specific UE are called contention based resources or channels.

At this time, the UE in a connected state, to inform the eNB of existence of the UE which has transmitted a uplink message through the contention based resources, has to transmit a UE identifier (for example, RNTI, C-RNTI) representing the corresponding UE to the eNB along with the messages.

Table 3 below shows one example of the UE identifier in the form of an MAC element.

TABLE 3

| | |
|---|---|
| Oct 1 | UE ID |
| Oct 2 | UE ID |

As shown in FIG. 22, the UE transmits a uplink message to the eNB through the UL contention based data region and carries out response waiting, selection or re-selection of radio resources for collision avoidance, or re-transmission of the uplink message based on the feedback information corresponding to the uplink message.

In FIG. 22, the UL contention based data region refers to contention based resources by which the UE transmits uplink data, while the DL region refers to a region which contains feedback information transmitted from the eNB.

Also, the UL conventional data region and the UL contention based data region may refer to a region in which operation of the UE is carried out according to the feedback information, where in the present embodiment, the allocation period of the UL contention based data region is assumed to be an even number.

Through the system information block described above or an RRC message in the unicast scheme, the eNB can inform the UE of the information about the physical region, transmission timing of the feedback information, and so on of the DL region which includes information about the physical region, allocation period, and the feedback information corresponding to the UL contention based data region.

The UE transmits a uplink message to the eNB through the UL contention based data region, and the eNB transmits feedback information to the UE through the DL region.

Afterwards, the UE can check through the feedback information whether the uplink message from the UE has been transmitted to the eNB; in case it is found that the uplink message has not been transmitted to the eNB, the UE can re-transmit the uplink message to the eNB through the UL contention based data region allocated subsequently.

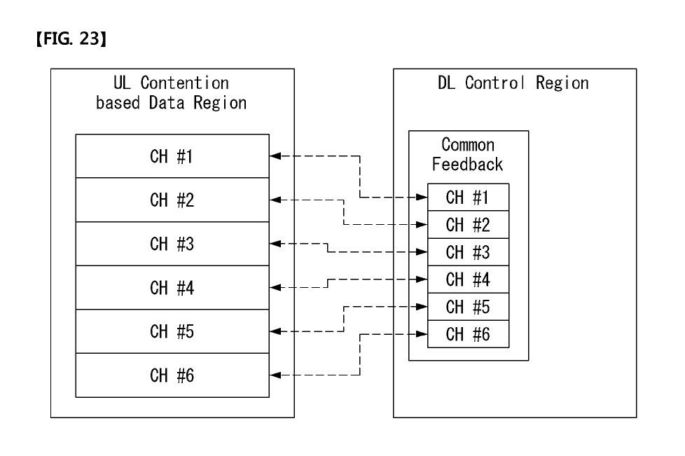

FIGS. 23 to 25 illustrate one example of a feedback channel through which feedback information to which the present invention can be applied is transmitted.

With reference to FIG. 23, individual contention based channels to which the UE transmits a uplink message are mapped to the respective feedback channels to which the corresponding feedback information is transmitted.

To be specific, contention based channels included in the UL contention based data region described in FIG. 22, namely, contention based channels to which the UE transmits a uplink message for providing a specific service have the respective feedback channels to which feedback information corresponding to the uplink message is transmitted.

In other words, in case the UE transmits a uplink message through the contention based channel 3 of FIG. 23, the UE can check through the feedback information transmitted through the feedback channel 3 included in the corresponding DL control region whether the eNB has received the uplink message.

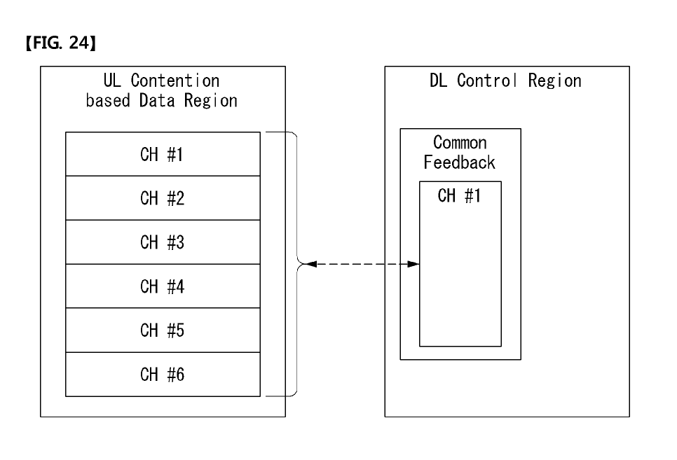

With reference to FIG. 24, a single feedback channel can be mapped to all of contention based channels included in the UL contention based data region to which a uplink message is transmitted.

To be specific, for all of contention based channels included in the UL contention based data region, one feedback channel can be defined. In other words, the feedback channel 1 included in the DL control region can include feedback information of a uplink message transmitted from all of the corresponding contention based channels.

At this time, the feedback information can include indices of one or more contention based channels; and information related to reception of a uplink message transmitted from a contention based channel corresponding to each contention based channel index.

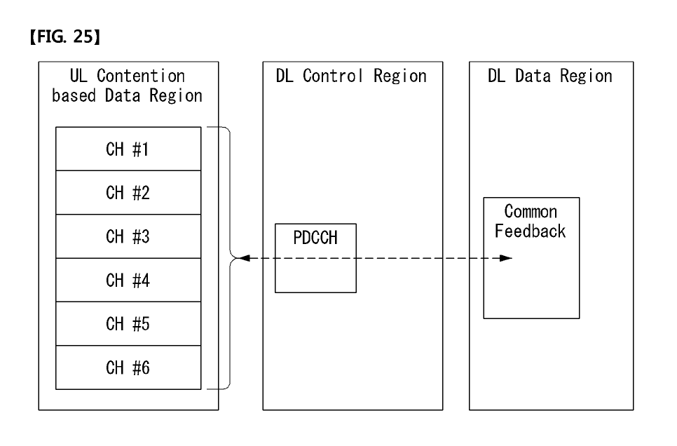

With reference to FIG. 25, a single feedback control signal can be mapped to all of contention based channels included in the UL contention based data region to which a uplink message is transmitted.

To be specific, a feedback control signal included in the DL data region corresponding to all of contention based channels included in the UL contention based data region can be defined. At this time, radio resource information within the DL data region to which the feedback control signal is transmitted is specified by the DL control region, and the feedback control signal can include feedback information about all of the corresponding contention based channels. In other words, the feedback information can include indices of one or more contention based channels; and information related to reception of a uplink message transmitted from a contention based channel corresponding to each contention based channel index.

Through the methods described in FIGS. 23 to 25, the UE can check reception of a uplink message transmitted through the contention based channel; in case the eNB fails to receive the uplink message, the UE can determine whether to re-transmit the uplink message.

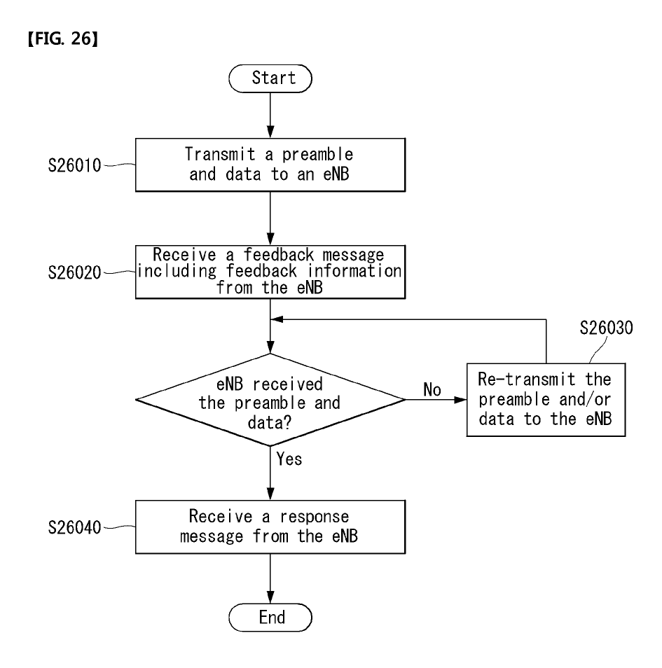

FIG. 26 is a flow diagram illustrating one example of transmitting uplink data through feedback information to which the present invention can be applied.

With reference to FIG. 26, the UE transmits a uplink message to the eNB through contention based resources and determines whether to re-transmit the uplink message through feedback information transmitted from the eNB.

To be specific, in case the UE in a connected state or an idle state receives specific service data, the UE transmits a preamble and the specific service data to the eNB through contention based resources. S26010.

At this time, the preamble is transmitted to inform of occurrence of the specific service data and transmission thereof to the eNB, where the preamble may not be transmitted.

Afterwards, the UE can receive a feedback message including feedback information from the eNB S26020.

The feedback information can include the preamble and/or the information indicating whether the eNB has received the specific service data, which can be transmitted through the feedback channel described in FIGS. 23 to 25.

Through the received feedback information, the UE can check whether the preamble and/or the specific service data have been properly transmitted to the eNB.

In case it is found that the eNB has failed to receive the preamble and/or the specific service data, the UE can re-transmit the preamble and/or the specific service data to the eNB S26030.

However, in case the eNB receives the preamble and/or the specific service data, the UE can receive a response message from the eNB S26040.

Through the method above, the UE can transmit the preamble and/or the specific service data to the eNB by using contention based resources and determine whether to re-transmit the preamble and the specific service data through the feedback information.

Also, since the UE can transmit the preamble and/or the specific service data without using the resources allocated by the eNB, the UE can transmit the preamble and/or the specific service data not only in the connected state but also in the idle state.

Also, since the UE can transmit the preamble and the specific service data through contention based resources without using specific resources allocated by the eNB, time for obtaining resources can be reduced.

In what follows, described will be a method for transmitting a message through contention based resources or contention based channels.

Transmission Method Using Contention Based Channels

A first transmission method using contention based channels can transmit a preamble and specific service data through a contention based channel. The preamble informs of the UE's transmission of the specific service data to the eNB.

The feedback information of the eNB can include the information shown in Table 4 or 5.

TABLE 4

| Value | Description |
|---|---|
| 0b00 | Preamble detection failure |
| | Data decoding failure |
| 0b01 | Success of detecting less than N preambles |
| | (N ≧ 2) |
| | The number of successful preamble detection is |
| | not consistent with the number of successful |
| | data decoding |
| 0b10 | Success of detecting N or more preambles |
| | The number of successful preamble detection is |
| | not consistent with the number of successful |
| | data decoding |
| 0b11 | The number of successful preamble detection is |
| | consistent with the number of successful data |
| | decoding |

TABLE 5

| Value | Description |
|---|---|
| 0b0 | Preamble detection failure |
| | Data decoding failure |
| 0b1 | Success of detecting 1 or more preambles |
| | Success of decoding 0 or more messages |

A second transmission method using contention based channels can transmit only specific service data through a contention based channel.

The feedback information of the eNB can include the information shown in Table 6.

TABLE 6

| Value | Description |
|---|---|
| 0b0 | Data decoding failure |
| 0b1 | Success of decoding 1 or more messages |

As another embodiment of the present invention, in case the eNB decides the preamble failure and a data decoding failure with respect to a specific contention based channel, the eNB may not transmit feedback information with respect to the specific contention based channel in the case of FIG. 23 or may not include feedback information with respect to the specific contention based channel in the case of FIG. 24. Thus, energy efficiency or efficiency of utilizing radio resources can be improved.

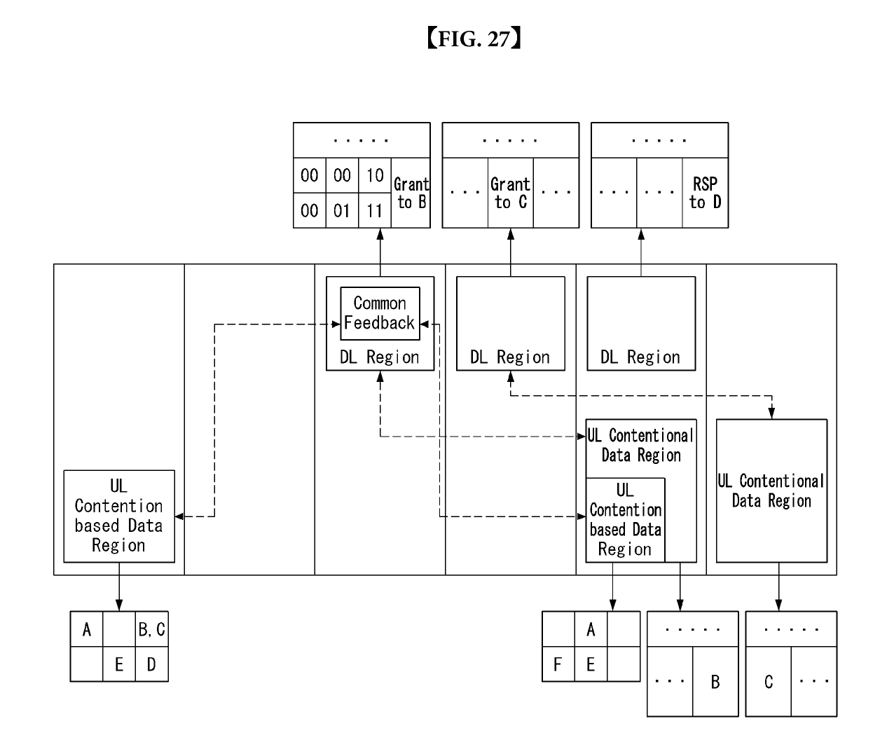

FIG. 27 illustrates one example of a method for UE A, B, C, D, E, and F to transmit and receive a specific service data under the following conditions among the methods for transmitting a uplink message by using a contention based channel described above.
Mapping between contention based channels and feedback channels as shown in FIG. 23
Transmission of a preamble and specific service data
Feedback information of Table 4 is included in a feedback message
N=2

To be specific, in the case of UE D, since the feedback information transmitted from a feedback channel corresponding to a contention based channel used by the UE D is ‘11’, which indicates that the number of successful preamble detection is the same as the number of successful data decoding, the UE D can decide that the eNB has successfully received preamble and specific service data that the UE D has transmitted.

Afterwards, the UE D starts a timer for receiving a response message from the eNB and waits for a response message of the eNB in response to the specific service data until the corresponding timer expires.

In case the UE D fails to receive the response message from the eNB until the timer is terminated, the UE D can decide that the preamble and the specific service data have not been transmitted to the eNB.

In case the UE D receives the response message from the eNB before the timer is terminated, the response message or CRC of the downlink radio resource information corresponding to the response message can be masked with an identifier (for example, CB-RNTI) mapped to the contention based channel used by the UE D or with an identifier (for example, C-RNTI) allocated to the UE D.

Table 7 illustrates one example of the range of an identifier mapped to the contention based channel.

TABLE 7

| Value | |
|---|---|
| (hexa-decimal) | RNTI |
| 0000 | N/A |
| 0001-003C | RA-RNTI, C-RNTI, Semi-Persistent |
| | Scheduling C-RNTI, Temporary C-RNTI, |
| | eIMTA-RNTI, TPC-PUCCH-RNTI and TPC-PUSCH- |
| | RNTI (see note) |
| 003D-FFF3 | C-RNTI, Semi-Persistent Scheduling C-RNTI, |
| | eIMTA-RNTI, Temporary C-RNTI, TPC-PUCCH- |
| | RNTI and TPC-PUSCH-RNTI, CB-RNTI |
| FFF4-FFFC | CB-RNTI |
| FFFD | M-RNTI |
| FFFE | P-RNTI |
| FFFF | SI-RNTI |

In the case of the UE E, since the feedback information transmitted from a feedback channel corresponding to a contention based channel used by the UE E is ‘01’, which indicates detection of 1 preamble, the UE E can decide that although the eNB has received a preamble that the UE E transmitted, the eNB failed to receive specific service data.

Therefore, the UE can re-transmit the specific service data to the eNB. At this time, the UE can re-transmit the specific service data by using a contention based channel which is the same as the contention based channel used before. For example, in case the UE E transmits the specific service data through a second channel among contention based channels, the UE E can re-transmit the specific service data by using the second channel again.

In the case of the UE A, since the feedback information transmitted from a feedback channel corresponding to a contention based channel used by the UE A is ‘00’, which indicates that the eNB has received nothing, the UE A can decide that the eNB has failed to receive the preamble and specific service data transmitted by the UE A.

Therefore, the UE A re-transmits the preamble and specific service data by selecting an arbitrary contention based channel from among the contention based channels except for the one occupied by the UE E. At this time, the UE A can transmit the preamble and specific service data by using one level higher transmission power.

Differently from the UEs A to D, the UE F transmits a preamble and specific service data by using a contention based channel of a second contention based data region allocated for the UEs A to E to re-transmit a preamble and/or specific service data.

At this time, the UE F can check a feedback channel corresponding to a first contention based data region to determine existence of a contention based channel occupied for the UEs A to D to re-transmit the preamble and/or specific service data.

The UE F which has checked the feedback channel can then transmit a preamble and specific service data by selecting an arbitrary contention based channel from among the contention based channels except for the one occupied for re-transmission purpose.

In the case of the UE B and C, since the feedback information transmitted from a feedback channel corresponding to a contention based channel used by the UE B and C is ‘10’, which indicates detection of two or more preambles and that the number of successful preamble detection is the same as the number of successful decoding of specific service data, the UE B and C can decide that although the eNB has successfully received the preamble transmitted by the UE B and C, whether the eNB has received the specific service data successfully is unknown.

The UE B and C operate a timer for uplink resource allocation and wait for uplink resources to be allocated to the UE B and C until the timer is terminated.

At this time, the eNB can carry out the operation below until the timer is terminated.
Successful reception of a preamble only: the eNB allocates uplink resources for transmission of the specific service respectively to the UE B and C. At this time, the CRC of each uplink resource information can be masked by an identifier (for example, CB-RNTI) which is mapped to the contention based channel utilized by the UE B and C.

The UE B and C can receive uplink resource information masked by an identifier mapped to the contention based channel utilized by the UEs, and if the index of a preamble included in the uplink resource information coincides with the index of a preamble that the UEs have transmitted, the UEs can consider the uplink resources as being allocated to them.

Afterwards, the UE B and C can retransmit the specific service data through the allocated uplink resources.
Successful reception of a preamble and specific service data: the eNB transmits a response message in response to the specific service data to the corresponding UE.

In case the eNB does not transmit a response message or uplink resources are not allocated until the timer is terminated, the UE B and C decide that the preamble and specific service data have not been transmitted and re-transmit the preamble and specific service data.

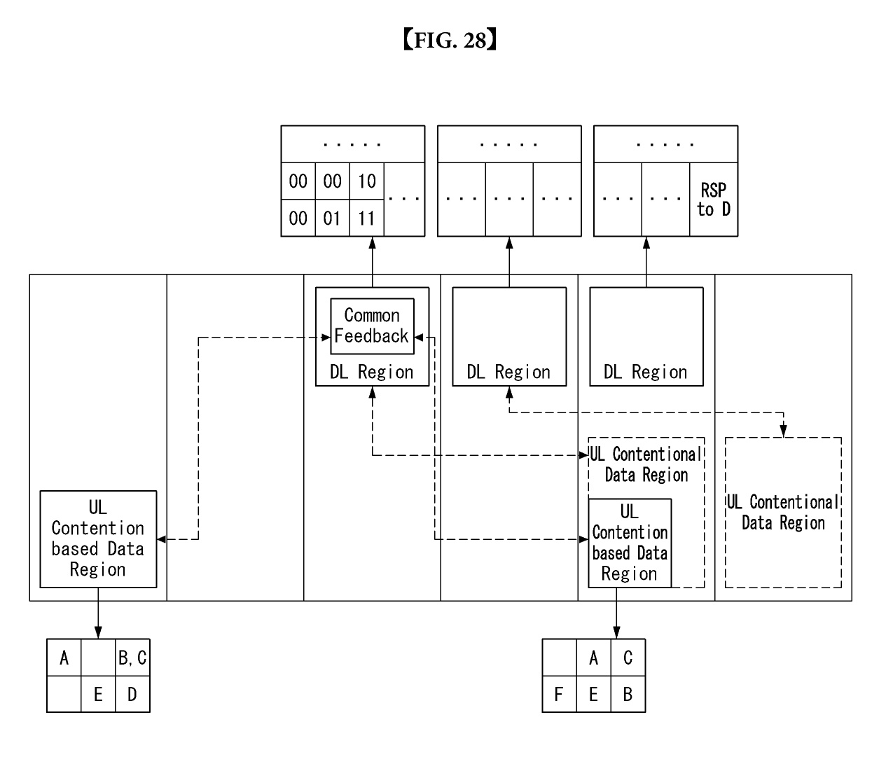

FIG. 28 illustrates one example of another operation of the UE B and C under the same conditions applied to FIG. 27.

As shown in FIG. 28, since the feedback information transmitted from a feedback channel corresponding to a contention based channel used by the UE B and C is ‘10’, which indicates detection of two or more preambles and that the number of successful preamble detection is not the same as the number of successful decoding of specific service data, the UE B and C can decide that although the eNB has successfully received the preamble transmitted by the UE B and C, whether the eNB has received the specific service data successfully is unknown.

At this time, in case the eNB succeeds to receive the preamble and specific service data transmitted by one of the UE B and C, the eNB transmits a response message to one of the UE B and C before a second contention based data region arrives.

In case the eNB is unable to transmit a response message before arrival of the second contention based data region due to processing time, the eNB can transmit a message indicating reception of the specific service data to the UE B or C.

However, in case the UE B or C fails to receive the response message, the UE B or C can re-transmit the preamble and specific service data by selecting an arbitrary channel from among contention based channels except for the one belonging to the second contention based data region occupied by another UE.

At this time, the UE B and C can select an arbitrary channel from among contention based channels except for the occupied contention based channel, select a neighboring channel around the contention based channel used before, or select one from among the channels from which feedback information is not ‘00’ or ‘01.

Also, the selection range of a contention based channel for the UE A and F can also vary according to through which method the UE B and C select a re-transmission channel.

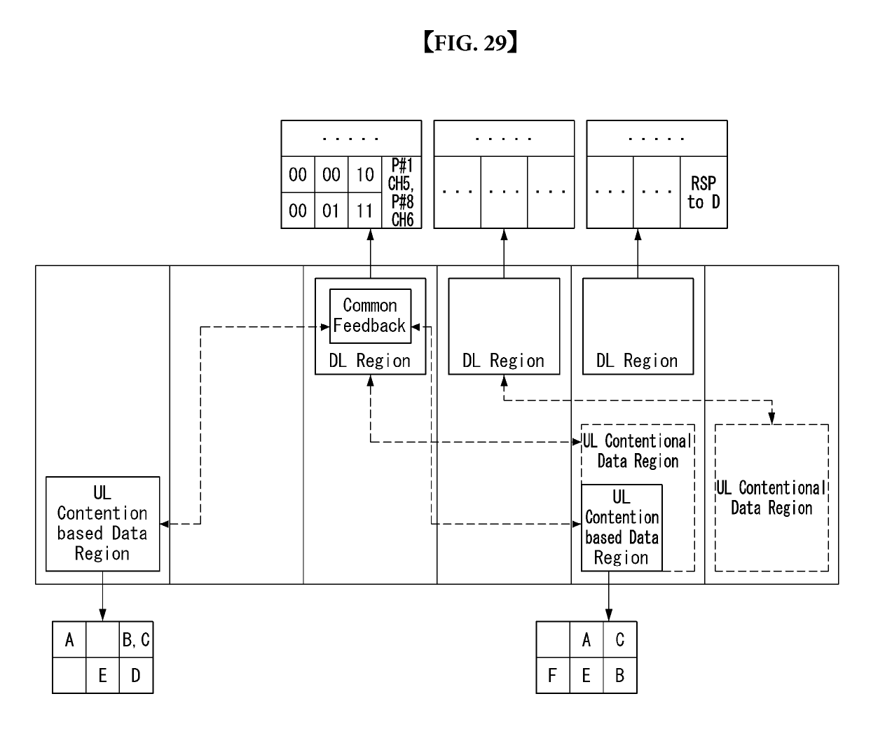

FIG. 29 illustrates one example of a yet another operation of the UE B and C under the same conditions applied to FIG. 27.

As shown in FIG. 29, since the feedback information transmitted from a feedback channel corresponding to a contention based channel used by the UE B and C is ‘10’, which indicates detection of two or more preambles and that the number of successful preamble detection is not the same as the number of successful decoding of specific service data, the UE B and C can decide that although the eNB has successfully received the preamble transmitted by the UE B and C, whether the eNB has received the specific service data successfully is unknown.

Also, the UE B and C checks information of contention based channels to be occupied respectively by the UE B and C among contention based channels of the second UL contention based data region through the eNB.

At this time, feedback information of ‘10’ is found, the UE A and F as well as the UE B and C can check the information of contention based channels to be occupied respectively by the UE B and C.

At this time, in case the eNB succeeds to receive the preamble and specific service data transmitted by one of the UE B and C, the eNB transmits a response message to one of the UE B and C before a second contention based data region arrives.

In case the eNB is unable to transmit a response message before arrival of the second contention based data region due to processing time, the eNB can transmit a message indicating reception of the specific service data to the UE B or C.

However, in case the UE B and C fails to receive the response message, the UE B and C can re-transmit the preamble and specific service data through contention based channels belonging to the second contention based data region occupied respectively by the UE B and C through the eNB.

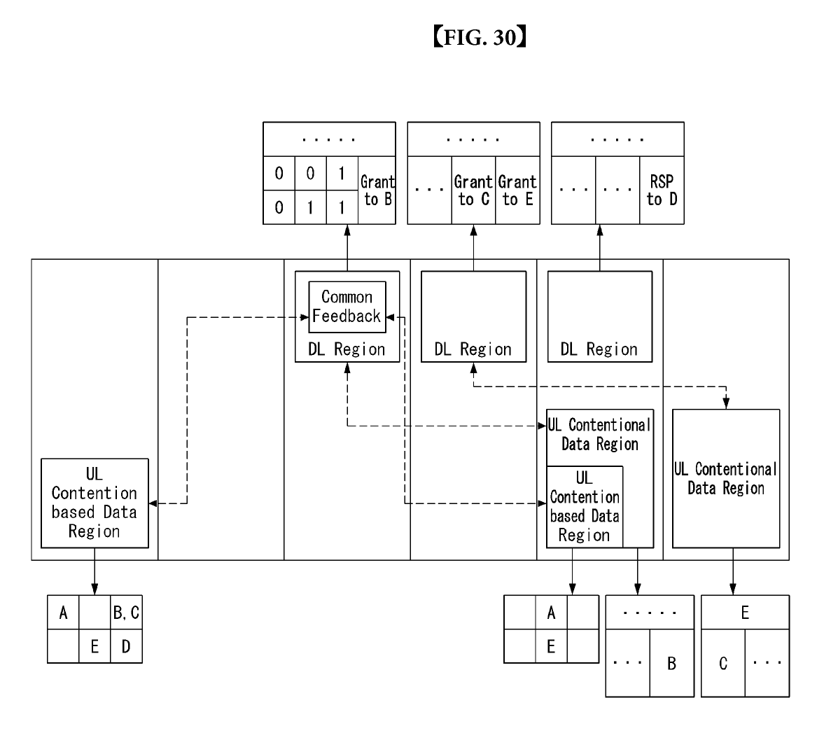

Differently from FIGS. 27 to 29, FIG. 30 illustrates another one example of a method for UE A, B, C, D, E, and F to transmit and receive specific service data under the following conditions.
Mapping between contention based channels and feedback channels as shown in FIG. 23
Transmission of a preamble and specific service data
Feedback information of Table 5 is included in a feedback message

To be specific, since the feedback information transmitted through a feedback channel corresponding to contention based channels used by the respective UEs is ‘1’, which indicates detection of 1 or more preambles and successful decoding of 0 or more specific service data, the UE B, C, D, and E can decide that although the eNB has successfully received the preambles transmitted respectively by the UEs, whether the eNB has received the specific service data successfully is unknown.

Therefore, the UE B, C, D, and E starts a timer to receive uplink transmission resources allocated by the eNB or to receive a response message from the eNB.

At this time, the eNB can carry out the following operation until the timer is terminated.
Successful reception of the preamble only (the UE B, C, and E): the eNB allocates uplink resources for transmission of the specific service data respectively to the UE B, C, and E. At this time, CRC of each uplink resource information can be masked with identifiers (for example, CB-RNTI) mapped to contention based channels used by the UE B and C.

The UE B, C, and E can receive masked uplink resource information by using identifiers mapped to the contention based channels used respectively by the UE B, C, and E; the UE B, C, and E decide that the uplink resources have been allocated thereto if indices of the preambles included within the uplink resource information coincide with the indices of preambles transmitted by the UE B, C, and E.

Afterwards, the UE B, C, and E can re-transmit the specific service data through uplink resources allocated to the UE B, C, and E.
Successful reception of preamble and specific service data (the UE D): the eNB transmits a response message in response to the specific service data to the UE D. At this time, the response message or CRC of the downlink resource information transmitted with respect to the response message can be masked with an identifier (for example, CB-RNTI) mapped to the contention based channel used by the UE D or with an identifier (for example, C-RNTI) allocated to the UE D.

In case the eNB does not transmit a response message or uplink resources are not allocated until the timer is terminated, the UE B, C, D, and E decide that the preamble and specific service data have not been transmitted and re-transmit the preamble and specific service data. For example, the example above may correspond to the case where the eNB received none of the preamble and specific service data transmitted from contention based channels selected by the UE B, C, D, and E.

Since the feedback information transmitted through a feedback channel corresponding to the contention based channel used by the UE A is ‘0’, which indicates failure to receive a preamble and specific service data, the UE A can decide that the eNB has failed to receive the preamble and specific service data.

Therefore, the UE A re-transmits the preamble and specific service data by selecting an arbitrary contention based channel from among the contention based channels belonging to the second UL contention based data region. At this time, the UE A can re-transmit the preamble and specific service data by using one level higher transmission power.

The UE F can transmit a preamble and specific service data to the eNB by selecting an arbitrary contention based channel from among the contention based channels belonging to the second contention based data region.

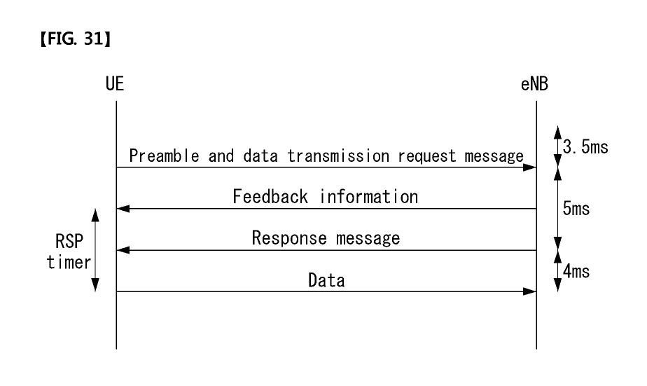

FIGS. 31 to 33 illustrate one example of transmission time of a uplink message according to the present invention.

FIG. 31 illustrates time periods required before data transmission is carried out in case the UE transmits a data transmission request message for transmitting a preamble and specific service data according to the present invention. The UE transmits the preamble and data transmission request message to the eNB.

The eNB detects the preamble, and in case the eNB successfully decodes the data transmission request message, the eNB transmits feedback information through a feedback channel corresponding to a contention based channel used by the UE.

At this time, the feedback information indicates that the eNB has successfully detected the preamble and received the transmission request message.

The UE receiving the feedback message can decide that the eNB has successfully received the preamble and the data transmission request message; and receives a response message from the eNB in response to the reception.

Afterwards, the UE can transmit specific service data to the eNB.

The time period required to process the procedure above can amount to 12.5 ms as shown in FIG. 31.

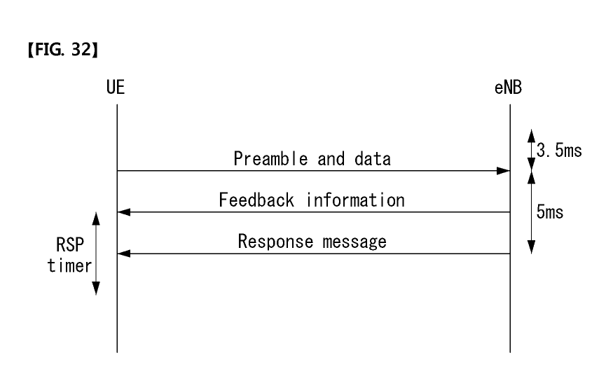

FIG. 32 illustrates time periods required before the specific service data are transmitted in case the UE transmits a transmission request message including a preamble and specific service data according to the present invention. The UE transmits the preamble and data transmission message to the eNB.

The eNB detects the preamble, and in case the eNB successfully decodes the data transmission message, the eNB transmits feedback information through a feedback channel corresponding to a contention based channel used by the UE.

At this time, the feedback information indicates that the eNB has successfully detected the preamble and received the transmission message.

The UE receiving the feedback message can decide that the eNB has successfully received the preamble and the data transmission request message; and receives a response message from the eNB in response to the reception.

The time period required to process the procedure above can amount to 8.5 ms as shown in FIG. 32.

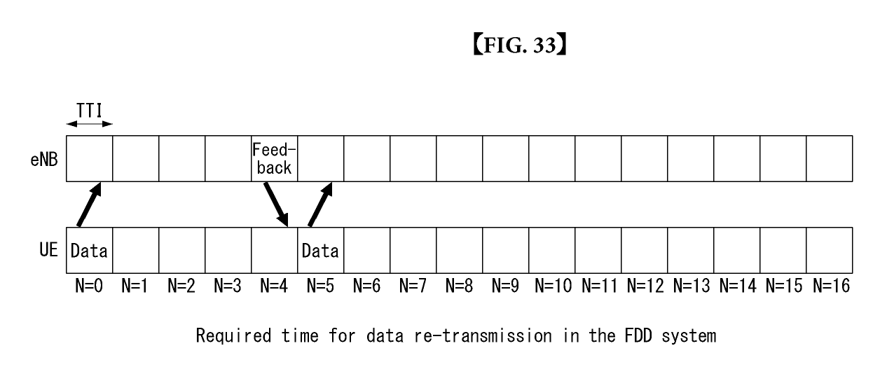

FIG. 33 illustrates re-transmission of uplink data through a contention based channel in the FDD system, which in this case requires a time period of 6 ms.

As described above, in case the preamble and specific service data are transmitted or re-transmitted according to the present invention, the required time can be reduced compared to the case of transmission through an RRC connection and resource allocation; moreover, since a preamble and/or data are transmitted being distributed across non-contention based resources and contention based resources, efficiency of utilizing radio resources can be improved.

Also, re-transmission is carried out by using other contention based resources rather than the contention based resources already occupied, collision among UEs can be avoided.

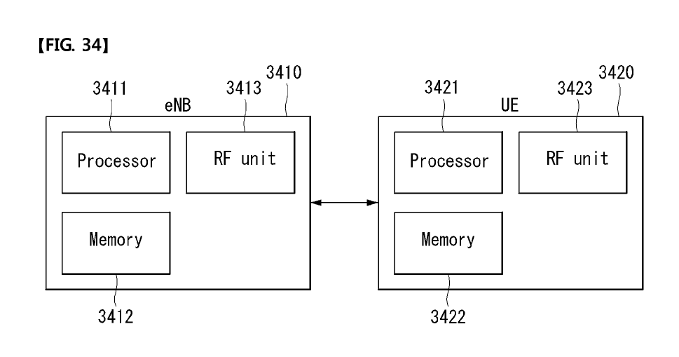

FIG. 34 illustrates one example of an internal block diagram of a wireless device to which the present invention can be applied.

In this case, the wireless device can be an eNB or a UE, where the eNB refers to both of a macro and a small eNB.

As shown in FIG. 34, the eNB 3410 and the UE 3420 include a communication unit (transmission and reception unit or Ratio Frequency (RF) unit) 3413, 3423, a processor 3411, 3421, and a memory 3412, 3422.

The eNB and the UE can further include an input unit and an output unit.

The communication unit 3413, 3423, the processor 3411, 3421, the input unit, the output unit, and the memory 3412, 3422 are connected functionally to each other to carry out the method according to the present invention.

The communication unit (transmission and reception unit or RF unit) 3413, 3423, receiving information generated from the Physical Layer (PHY) protocol, transforms the received information into the Radio-Frequency (RF) spectrum, applies filtering or amplification on the information, and transmits the processed information through an antenna. Also, the communication unit transforms an RF signal received from the antenna to the spectral domain where the received RF signal can be processed according to the PHY protocol and carries out filtering on the transformed signal.

And the communication unit can include a function for switching between transmission and reception function.

The processor 3411, 3421 implements a function, process, and/or method proposed in this document. Layers of radio interface protocols can be implemented by the processor.

The processor can also be called a controller, a control unit, or a computer.

The memory 3412, 3422, being connected to the processor, stores a protocol or parameters for carrying out a method for allocating uplink resources.

The processor 3411, 3412 can include Application-Specific Integrated Circuit (ASIC), other chipsets, logical circuit, and/or a data processing device. The memory can include Read-Only Memory (ROM), Random Access Memory (RAM), flash memory, memory card, storage medium and/or other storage devices. The communication unit can include a baseband circuit to process a radio signal. If an embodiment is implemented by software, the techniques described above can be implemented in the form of a module (process or function) which performs the function described above.

A module can be stored in the memory and can be executed by the processor. The memory can be located inside or outside the processor and can be connected to the processor through a well-known means.

The output unit (or display unit) is controlled by the processor and outputs information generated by the processor along with key input signals generated from the input unit and various information signals coming from the processor.

Various substitutions, modifications, and changes can be made to the present invention described above by those skilled in the art to which the present invention belongs without leaving the technical scope of the present invention; therefore, the present invention is not limited to the embodiments above and appended drawings.

### INDUSTRIAL APPLICABILITY

This document discloses a method for RRC connection in a wireless communication system based on the 3GPP LTE/LTE-A system; however, the present invention can be applied to various other types of wireless communication systems in addition to the 3GPP LTE/LTE-A system.

What is claimed is:

1. A method for transmitting and receiving data, by a user equipment (UE), for providing a specific service in a wireless communication system, the method comprising:
transmitting a preamble and data for the specific service to an eNB;
receiving feedback information carrying a reception result of the preamble and the data from the eNB; and
re-transmitting at least one of the data or the preamble, if the feedback information indicates failure of reception of at least one of the data or the preamble,
wherein the preamble and the data are transmitted through a first contention based channel, the first contention based channel is not a dedicated channel for a specific UE.

2. The method of claim 1, the method further comprising:
receiving a response message in response to the data from the eNB, if the feedback information indicates reception of the preamble and the data.

3. The method of claim 2,
wherein the response message is masked with a UE identifier or a channel identifier representing the contention based channel.

4. The method of claim 1, wherein the re-transmitting step further comprises,
receiving resources allocated for re-transmission of the data from the eNB, if the feedback information indicates reception of the preamble only; and
re-transmitting the data through the allocated resources.

5. The method of claim 1,
Wherein the preamble and the data are retransmitted to the eNB through the first contention based channel, if the feedback information indicates reception of the preamble only.

6. The method of claim 1,
wherein the preamble and the data are retransmitted to the eNB through a second contention based channel, if the feedback information indicates reception of the preamble only, and
wherein the second contention based channel is different from the first contention based channel.

7. The method of claim 1,
wherein the preamble and the data are retransmitted to the eNB through the first contention based channel, if the feedback information indicates failure of reception of the preamble and the data.

8. The method of claim 1,
wherein, the preamble and the data are retransmitted to the eNB through the second contention based channel, if the feedback information indicates failure of reception of the preamble and the data.

9. The method of claim 1,
wherein the feedback information is transmitted through a specific channel corresponding to the contention based channel.

10. A user equipment (UE) for transmitting and receiving data for providing a specific service in a wireless communication system, the UE comprising:
a communication unit transmitting and receiving a radio signal to and from an external entity; and
a processor functionally linked to the communication unit, wherein the processor is configured to transmit a preamble and data for the specific service to an eNB;
to receive feedback information carrying a reception result of the preamble and the data from the eNB; and
to re-transmit at least one of the data or the preamble, if the feedback information indicates failure of reception of at least one of the data or the preamble,
wherein the preamble and the data are transmitted through a first contention based channel, the first contention based channel is not a dedicated channel for a specific UE.

11. The UE of claim 10,
wherein, if the feedback information indicates receiving the preamble and the data, the processor is configured to receive a response message in response to the data from the eNB.

12. The UE of claim 11,
wherein the response message is masked with a UE identifier or a channel identifier representing the contention based channel.

13. The UE of claim 10,
wherein, if the feedback information indicates reception of the preamble only, the processor is configured to receive resources allocated for re-transmission of the data from the eNB and to re-transmit the data through the allocated resources.

14. The UE of claim 10,
wherein, the preamble and the data are re-transmitted to the eNB through the first contention based channel, if the feedback information indicates reception of the preamble only.

15. The UE of claim 10,
wherein, the preamble and the data are re-transmitted to the eNB through a second contention based channel, if the feedback information indicates reception of the preamble only, and
wherein the second contention based channel is different from the first contention based channel.

16. The UE of claim 10,
wherein, the preamble and the data are retransmitted to the eNB through the first contention based channel, if the feedback information indicates failure of reception of the preamble and the data.

17. The UE of claim 10,
wherein, the preamble and the data are retransmitted to the eNB through the second contention based channel, if the feedback information indicates failure of reception of the preamble and the data.

18. The UE of claim 10,
wherein the feedback information is transmitted through a specific channel corresponding to the contention based channel.
